(19) United States
(12) Patent Application Publication
(10) Pub. No.: US 2023/0314571 A1
(43) Pub. Date: Oct. 5, 2023

(54) DETECTION APPARATUS, SCANNING UNIT, MOVABLE PLATFORM, AND CONTROL METHOD OF DETECTION APPARATUS

(71) Applicant: SZ DJI TECHNOLOGY CO., LTD., Shenzhen (CN)

(72) Inventors: Chenghui LONG, Shenzhen (CN); Bowen LI, Shenzhen (CN); Li WANG, Shenzhen (CN); Yang YANG, Shenzhen (CN); Likui ZHOU, Shenzhen (CN); Zezheng ZHANG, Shenzhen (CN); Cong XIONG, Shenzhen (CN)

(73) Assignee: SZ DJI TECHNOLOGY CO., LTD., Shenzhen (CN)

(21) Appl. No.: 18/206,221

(22) Filed: Jun. 6, 2023

Related U.S. Application Data
(63) Continuation of application No. PCT/CN2020/142434, filed on Dec. 31, 2020.

(51) Int. Cl. G01S 7/481; G01S 17/89; G01S 7/4865

(52) U.S. Cl. CPC G01S 7/4817; G01S 17/89; G01S 7/4865

(57) ABSTRACT

A detection apparatus may include a light source to emit a light pulse sequence, a first scanner and a second scanner disposed in an optical path of the light pulse sequence to change propagation direction of the light pulse sequence. The first scanner alone may be capable of causing an outgoing light beam to scan along a first path, and the second scanner alone may be capable of causing the outgoing light beam to scan along a second path. The first scanner may include a reflector and a first driver; and the second scanner may include a reflective structure and a second driver, the reflective structure including at least two reflective surfaces. The second driver may drive the reflective structure to rotate so that the at least two reflective surfaces are rotated sequentially onto the optical path of the light pulse sequence.

### CROSS-REFERENCE TO RELATED APPLICATIONS

The present application is a continuation of International Application No. PCT/CN2020/1424371, filed Dec. 31, 2020, the entire contents of which being incorporated herein by reference in its entirety.

### TECHNICAL FIELD

This application relates to the technical field of detection equipment, in particular, a detection apparatus, a scanning unit, a movable platform and a control method of the detection apparatus.

### BACKGROUND

The application of detection equipment in autonomous driving scenarios generally requires a horizontal field of view of more than 100°, long range, high scanning density, and uniform scanning trajectory. Conventional detection equipment achieves these requirements by arranging more light emitters in a vertical field of view and driving the light emitters to rotate in the horizontal field of view through drive motors, thereby achieving a large coverage in the horizontal field of view. However, the conventional detection equipment requires a plurality of light emitters and has low reliability and high cost.

### SUMMARY

This application provides a detection apparatus, a scanning unit, a movable platform and a control method for the detection apparatus, which improves reliability and reduces cost of the detection apparatus.

In a first aspect, some embodiments of the present application provide a detection apparatus comprising a light source to emit a light pulse sequence; a first scanner and a second scanner disposed in an optical path of the light pulse sequence to change propagation direction of the light pulse sequence. The first scanner alone may be capable of causing an outgoing light beam to scan along a first path, and the second scanner alone may be capable of causing the outgoing light beam to scan along a second path. The first scanner may include a reflector and a first driver to drive the reflector to swing back and forth in a stepwise manner; and the second scanner may include a reflective structure and a second driver, the reflective structure including at least two reflective surfaces. The second driver may drive the reflective structure to rotate so that the at least two reflective surfaces are rotated sequentially onto the optical path of the light pulse sequence to cause the detection apparatus to form a scan in a two-dimensional direction.

In a second aspect, some embodiments of the present application provide a movable platform comprising.
a platform body; and
a detection apparatus according to one embodiment of the present application provided on the platform body.

Some embodiments of the present application provide a detection apparatus, a scanning unit, a movable platform and a detection apparatus control method, through the first scanner and the second scanner set in turn, can cause the detection apparatus to form a two-dimensional direction of the scan, to obtain a large field of view, without the need to design many light sources and the light sources do not need to rotate, thereby having high reliability and low costs.

It should be understood that the above general description and the later detailed descriptions are exemplary and explanatory only and do not limit the disclosure of embodiments of the present application.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is a schematic diagram of a structure of a detection apparatus provided by an embodiment of the present application;

FIG. 2 is a schematic diagram of a structure of a reflector provided by an embodiment of the present application;

FIG. 3 is a schematic diagram of a part of a structure of a detection apparatus provided by an embodiment of the present application;

FIG. 4 is a schematic diagram of an embodiment of a point cloud obtained by scanning of a detection apparatus in an embodiment of the present application;

FIG. 5 is a schematic diagram of a structure of a detection apparatus provided by an embodiment of the present application;

FIG. 6 is a schematic diagram of a scan trajectory corresponding to a local field of view δ2 in FIG. 5;

FIG. 7 is a schematic diagram of a structure of a reflective structure provided by an embodiment of the present application;

FIG. 8 is a schematic diagram of a part of a structure of a detection apparatus provided by an embodiment of the present application, wherein the dashed line with an arrow indicates an optical path;

FIG. 9 is a schematic diagram of a structure of a reflective structure provided by an embodiment of the present application;

FIG. 10 is a schematic view of a detection apparatus in FIG. 9 in a vertical field of view;

FIG. 11 is a schematic diagram of a structure of a detection apparatus provided by embodiments of the present application;

FIG. 12 is a schematic diagram of a part of a structure of a detection apparatus provided by an embodiment of the present application, in which a first prism and a second prism are illustrated;

FIG. 13 is a schematic diagram of a structure of a detection apparatus provided by embodiments of the present application;

FIG. 14 is a schematic diagram of a structure of a detection apparatus provided by an embodiment of the present application;

FIG. 15 is a schematic diagram of a structure of a housing provided by embodiments of the present application;

FIG. 16 is a schematic diagram of a structure of a low-reflectivity wall provided by an embodiment of the present application;

FIG. 17 is a schematic diagram of a structure of a detection apparatus provided by an embodiment of the present application;

FIG. 18 is a schematic diagram of a scanning trajectory obtained by a drive mechanism driving a first prism and a second prism to oscillate at an equal speed of 300 rpm and a drive module driving the reflection module to rotate at an equal speed of 6000 rpm;

FIG. 19 is a schematic diagram of the scanning trajectory obtained by the drive mechanism driving the first prism and the second prism to oscillate at a sinusoidal variable speed and the drive module driving the reflection module to rotate at 6000 rpm;

FIG. 20 is a schematic diagram of a structure of a movable platform provided by an embodiment of the present application; and

FIG. 21 is a flow diagram of a control method of a detection apparatus provided by an embodiment of the present application.

### DESCRIPTION OF THE ATTACHED MARKERS

1000, movable platforms.
100, Detection apparatuss.
10, light source; 11, first path; 12, second path; Y, direction of extension of the first path; X, direction of extension of the second path.
20, first scanning module or scanner; 21, reflector; 22, driving mechanism; 23, first prism; 24, second prism.
30, second scanning module or scanner; 31, reflective module or structure; 311, reflective surface; 312, first reflective surface; 3121, first edge region; 3122, second edge region; 3123, first intermediate region; 313, second reflective surface; 3131, third edge region; 3132, fourth edge region; 3133, second intermediate region; 314, third reflective surface 315, junction area; 32, drive module or structure; 33, photoelectric code disk
40, control unit or controller.
50, reflective elements or structures.
60, housing; 61, light-blocking segment; 611, low-reflectivity wall; 612, wall body; 613, low-reflectivity layer; 62, light-transmitting segment; 621, first light-transmitting zone; 622, second light-transmitting zone.
70, collimating elements or structures.
200, Platform Ontology.
21A, first attitude; 21B, second attitude.

### DETAILED DESCRIPTION

The following will be a clear and complete description of the technical solutions in the embodiments of this application in conjunction with the accompanying drawings in the embodiments of this application, and it is clear that the embodiments described are a part of the embodiments of this application, and not all of them. Based on the embodiments in the present application, all other embodiments obtained by a person of ordinary skill in the art without making creative labor fall within the scope of protection of the present application.

In the description of this application, it is to be understood that the terms “center”, “longitudinal”, “transverse”, “length”, “width”, “thickness”, “top”, “bottom”, “front”, “back”, “left”, “right”, “vertical”, “horizontal”, “top”, “bottom”, “inside”, “outside”, “clockwise”, “counterclockwise” and the like indicate orientation or positional relationships based on the orientation or positional relationships shown in the accompanying drawings and are intended only to facilitate and simplify the description of this application, and does not indicate or imply that the apparatus or element referred to must have a particular orientation, be constructed and operate in a particular orientation, and therefore cannot be construed as a limitation of the application. Furthermore, the terms “first” and “second” are used for descriptive purposes only and are not to be construed as indicating or implying relative importance or implicitly specifying the number of technical features indicated. Thus, the features qualified with “first” and “second” may explicitly or implicitly include one or more of the described features. In the description of this application, “plurality” means two or more, unless otherwise expressly and specifically limited.

It should also be understood that the terminology used in the specification of this application is for the purpose of describing particular embodiments only and is not intended to limit the application. As used in the specification of this application and the appended claims, unless the context clearly indicates otherwise, the singular forms “one,” “a,” and “the” are intended to include the plural forms.

It is further understood that the term “and/or” as used in the specification of this application and the appended claims refers to any and all possible combinations of one or more of the items listed in connection therewith, and includes such combinations.

The inventors of this application found that during the driving of an autonomous vehicle, stones scattered on the road, vehicles coming from the opposite direction, pedestrians who are crossing the road, etc., can be regarded as obstacles for which it needs to perform avoidance. Only with effective obstacle detection and tracking can the corresponding control scheme be developed, i.e., the path planning of the vehicle be realized. For this reason, LIDAR is widely used in autonomous driving scenarios. The application of LIDAR in autonomous driving scenarios generally requires a large horizontal field of view and a vertical field of view. The horizontal field of view usually requires more than 100° and is larger than the vertical field of view.

Traditional methods for achieving a larger field of view include multilinear rotation schemes, rotating prism or oscillator schemes, rotating reflector schemes, and combined multi-prism rotation schemes.

The multi-line rotation scheme refers to that the laser radar arranges more transmitting and receiving modules in the vertical field of view, and drives the optical transmitter to rotate in the horizontal field of view by driving the motor, so as to achieve a large coverage area in the horizontal field of view and a vertical field of view and improves the scanning density. However, this kind of LIDAR requires many independent transmitting and receiving modules with high material cost and production process cost. In addition, the transmitter-receiver circuit components need to rotate in motion during the operation of this LIDAR, and the reliability risk is high.

The rotating oscillator scheme can obtain high-density scanning, but the through-aperture is small, the general range is close, the deflection angle of the oscillator cannot be too large, and it is necessary to obtain a large field of view by combining multiple oscillators.

The rotating single-sided reflector solution allows for a larger field of view, but the size of the reflector is usually larger.

The multi-prism rotation combination scheme requires an angular prism size to obtain a larger field of view. In addition, the polygon mirror scans within one detection frame, and a time difference between scanning to measurement points in a same area is relatively large, and the measurement points of a high-speed moving object may have smear, which affects recognition of the high-speed moving object.

To this end, the inventors of this application have improved the detection apparatus, scanning unit, movable platform and the control method of the detection apparatus in order to ensure reliability of the detection apparatus and reduce costs while obtaining a large field of view in the horizontal direction.

Some embodiments of the present application are described in detail below in conjunction with the accompanying drawings. The following embodiments and features in the embodiments can be combined with each other without conflict.

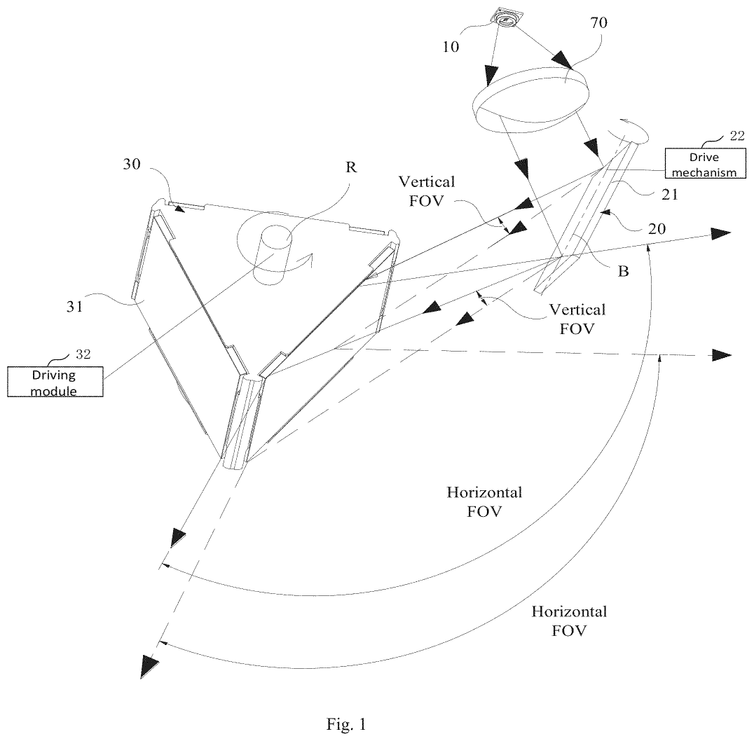

Referring to FIG. 1, one embodiment of the present application provides a detection apparatus 100, which is used to detect external environmental information, such as distance information, orientation information, reflection intensity information, speed information, etc. of environmental targets.

Exemplarily, the detection apparatus 100 can include electronic apparatus such as radar, ranging equipment, such as LIDAR or laser ranging equipment.

Exemplarily, the detection apparatus 100 can be applied to spatial scene simulation, automatic obstacle avoidance systems, 3D imaging systems, 3D modeling systems, remote sensing systems, mapping systems, navigation systems, and the like. For example, the detection apparatus 100 is applied in automatic obstacle avoidance systems of movable platforms 1000 such as unmanned aerial vehicles and unmanned vehicles.

Exemplarily, the detection apparatus 100 can detect the distance from the detection object to the detection apparatus 100 by measuring the time of light propagation between the detection apparatus 100 and the detection object, i.e., time-of-flight (TOF). Alternatively, the detection apparatus 100 may also detect the distance from the detection object to the detection apparatus 100 by other techniques, such as ranging methods based on phase shift (phase shift) measurements, or ranging methods based on frequency shift (frequency shift) measurements, without limitation herein.

In some embodiments, the detection apparatus includes a light source, a first scanning module or scanner, and a second scanning module or scanner. The light source is used to emit a sequence of light pulses, such as a laser pulse sequence. The first scanning module and the second scanning module are provided on the light path of the light pulse sequence. The first scanning module and the second scanning module are each used to sequentially change the propagation direction of the light pulse sequence. There is no restriction on the order in which the first scanning module and the second scanning module are set on the optical path of the light pulse sequence in this embodiment of the disclosure. Optionally, the first scanning module alone can realize the outgoing beam scanning along the first path, and the second scanning module alone can realize the outgoing beam scanning along the second path, the first path and the second path have different extension directions. Therefore, through the sequential setting of the two scanning modules on the optical path, the light pulse sequence from the detection apparatus can form a two-dimensional direction of scanning, and obtain a large field of view. There are many advantages for these detection apparatus such as no need to design many light sources and light sources do not need to rotate, high reliability, and low costs. In addition, the time difference between the detection apparatus scanning to the same area is small, which reduces the risk of smearing at the measurement points of high-speed moving objects, does not affect the recognition of high-speed moving objects, and improves accuracy of high-speed moving object recognition.

The first path may be curved (e.g., circular in shape). For example, the first scanning module may include a prism having two surfaces that are not parallel to each other, and a drive mechanism or driver for driving the prism to rotate. The first scanning module alone can be implemented to allow the sequence of light pulses to scan along a circular scanning path. For example, the first scanning module may include two prisms having two surfaces that are not parallel to each other, and a drive mechanism for driving each of the two prisms to rotate. By setting the different rotational speeds of the two prisms, the first scanning module alone can be used to allow the light pulse sequence to scan along a complex pattern.

Alternatively, the first path may be in a straight line. For example, by controlling the two prisms to rotate in opposite directions at equal speed by a drive mechanism, the first scanning module alone can achieve a sequence of light pulses that scan back and forth in a generally straight line. For example, the first scanning module includes a reflector or a MENS mirror, and includes a drive mechanism for driving the mirror to vibrate or oscillate in a fixed axis, and the first scanning module alone can be used to make the light pulse sequence repeat along a straight line. For example, the first scanning module includes a reflector module, which includes at least two reflective surfaces; the first scanning module also includes a rotating mechanism for driving the reflector module so that the at least two reflective surfaces rotate sequentially on the optical path of the light pulse sequence. The first scanning module alone enables the light pulse sequence to be repeatedly scanned along a linear segment AB perpendicular to the rotation axis of the reflector module from point A to point B along the line segment AB.

The second path can be curved or linear, and the second scanning module can realize the curved or linear scanning path in the way described above for the first scanning module, and will not be repeated here. In one example, the first scanning module alone can realize the light pulse sequence scanning along a straight line, and the second scanning module alone can realize the light pulse sequence scanning along a straight line, and the combination of the two scanning modules can realize the light pulse sequence scanning to get a two-dimensional matrix-like point cloud array so as to get a uniformly distributed point cloud, which is more conducive to subsequent recognition and analysis of the point cloud algorithm implementation. Optionally, the first path is perpendicular to the second path, so that the combination of the two scanning modules can achieve a rectangular array of point clouds. Alternatively, the first path and the second path may be at a certain angle. For example, the angle between the first path and the second path is greater than 45°. Exemplarily, the angle between the first path and the second path can be designed according to the actual needs, for example, the angle between the first path and the second path is less than or equal to 90°. Exemplarily, the angle between the first path and the second path is greater than 45° and less than or equal to 90°, for example, 50°, 60°, 70°, 80°, 85°, 90°, and any other suitable angle between 45° and 90°. In some embodiments, the first path extends in a vertical direction (e.g., in the direction of gravity) and the second path extends in a horizontal direction.

The control of the drive mechanism for driving the movement of the scanning elements in the first scanning module and the second scanning module can be continuous or stepwise. For example, the drive mechanism may be continuous in driving the prism rotation, which may be repeated by rotating one step at a time and then stopping and rotating another step. Another example is that the drive mechanism, when driving a reflective module comprising at least two reflective surfaces to rotate, may be continuous rotation, or may be repeated by rotating one step at a time and then stopping and rotating another step. Another example is that the drive mechanism, when driving the reflector to swing back and forth around a fixed axis, may be continuously swinging or rotating back and forth over an angular range, or may be swinging over an angular range for multiple steps, or rotating through multiple steps. Compared with the continuous driving method, the step driving method can help to control the attitude of the scanning elements more precisely, which in turn helps to form a more regular and uniformly arranged point cloud, but the continuous driving method is more conducive to achieving fast scanning than the step driving method, which is more suitable for some applications where scanning speed is required.

Some of the detection apparatuses in some embodiments of the present disclosure are further explained specifically in the following in conjunction with the accompanying drawings. First, the detection apparatus in which the first scanning module includes a reflector and a drive mechanism or first driver for driving the oscillation of the reflector, and the second scanning module includes a reflective module having at least two reflective surfaces and a drive module or second driver for driving the rotation of the reflective module, are explained specifically below in connection with FIG. 1. It is noted that other descriptions of the detection apparatus below also apply to detection apparatuses having other types of first scanning modules and second scanning modules.

Referring to FIG. 1, in some embodiments, the detection apparatus 100 includes a light source 10, a first scanning module 20, and a second scanning module 30. The light source 10 is used to emit a sequence of light pulses, such as a sequence of laser pulses. The first scanning module 20 and the second scanning module 30 are provided in sequence on the optical path of the light pulse sequence, respectively, for sequentially changing the propagation direction of the light pulse sequence.

The first scanning module 20 includes a reflector 21 and a drive mechanism 22. The drive mechanism 22 is used to drive the reflector 21 to swing back and forth along a swing axis.

Exemplarily, the reflector 21 may include a reflector with a large area, or it may include a Micro-Electro-Mechanical System (MEMS) mirror with a small area, etc., without limitation herein. Exemplarily, the reflector 21 is a Micro-Electro-Mechanical System (MEMS) oscillator. A micro actuator is integrated in the drive mechanism 22. The drive mechanism 22 can drive the mirror 21 to swing back and forth by the micro-actuator. Exemplarily, the mirror 21 is provided on the micro-actuator of the drive mechanism 22 to change the propagation direction of the light pulse sequence emitted by the light source 10 so that the outgoing light beam is scanned along the first path.

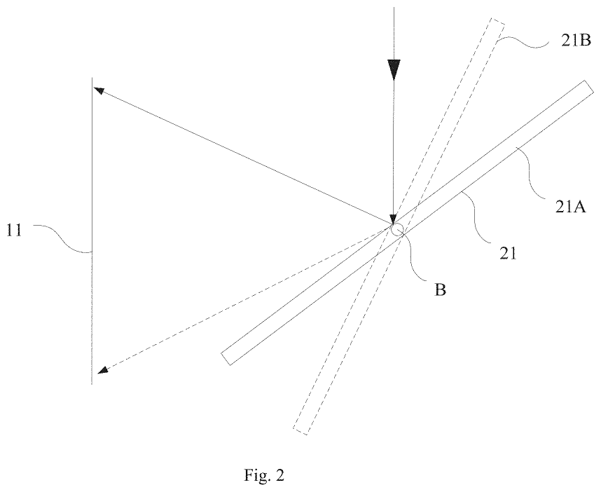

As shown in FIG. 2, FIG. 2 is a schematic diagram of a structure of a reflector provided by an embodiment of the present application. The solid line box and the dashed line box indicate two different attitudes of the reflector, respectively. The drive mechanism 22 is used to drive the reflector 21 to swing from the first attitude 21A to the second attitude 21B in at least one step deflection with axis B. In one example, the incident optical path of the light pulse sequence incident to the reflector 21 is held stationary, and during the swing of the reflector 21 from the first attitude to the second attitude shown in FIG. 2, the light pulse sequence is scanned along the first path 11 from an upper end of the first path to a lower end of the first path.

Exemplarily, the detection apparatus 100 acquires point cloud data when the mirror 21 moves from the first attitude to the second attitude. The drive mechanism 22 is used to drive the reflector 21 to swing at least two steps in the same direction from the first attitude to the second attitude. The field of view of the extension direction of the first path is determined according to the first and second attitudes. In the case where the first attitude and the second attitude are determined, the reflector 21 swings at least two steps from the first attitude to the second attitude in the same direction to enable the acquired point cloud data to be more intensive.

Understandably, the shape of the reflective surface 311 of the reflector 21 is designed to be any suitable shape according to the shape or arrangement of the light spot. For example, the shape of the reflector 21 includes oval, square, and the like. Exemplarily, the shape of the reflective surface 311 of the reflector 21 includes any suitable shape such as oval, square, etc. In this way, it is possible to meet the light path design, but also to reduce waste of materials as much as possible, thereby reducing costs.

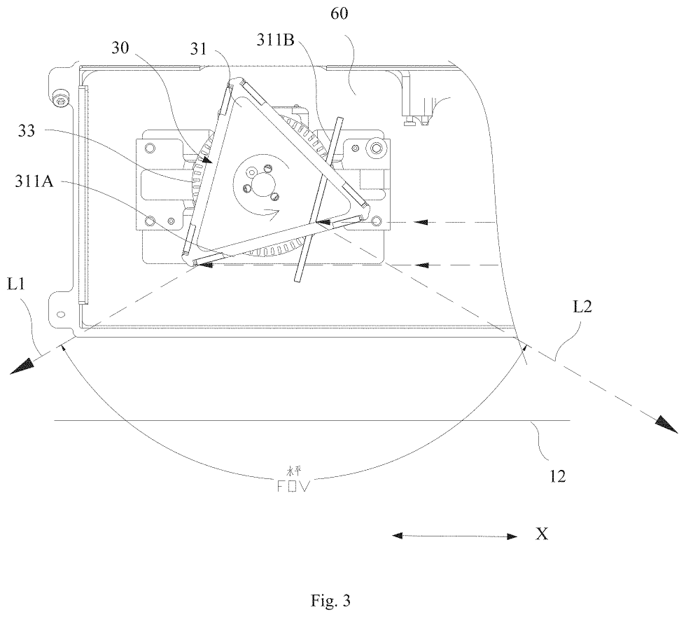

Exemplarily, the second scanning module 30 includes a reflective module 31 and a driving module 32. The reflective module 31 includes at least two reflective surfaces 311, and the driving module 32 is used to drive the reflective module 31 to rotate such that the at least two reflective surfaces 311 rotate sequentially onto the optical path of the optical pulse sequence. As shown in FIG. 3, FIG. 3 is a schematic diagram of a part of the structure of a detection apparatus provided by an embodiment of the present application. The reflective module includes three end-to-end connected reflective surfaces, that is, a first reflective surface 312, a second reflective surface 313 and a third reflective surface 314. Optionally, a junction area is also provided between two adjacent reflective surfaces. For example, the reflective module 31 also includes a junction area 315 between the second reflective surface 313 and the third reflective surface 314. The second reflective surface 313, the junction area 315, and the third reflective surface 314 are provided sequentially in the rotation direction of the reflective module 31. Both the second reflective surface 313 and the third reflective surface 314 are connected to the junction area 315. When the driver module drives the rotation of the reflective module 31, the first reflective surface 312, the second reflective surface 313 and the third reflective surface 314 are sequentially rotated to the optical path of the light pulse sequence.

In one example, the incident light path of the sequence of light pulses incident to the reflective module 31 is held stationary and the reflective module 31 shown in optical path of FIG. 2 is rotated counterclockwise: when the first reflective surface 312 is rotated to position 311A, the incident light pulses are reflected to exit along the optical path L1; when the first reflective surface 312 is rotated to position 311B, the incident light pulses are reflected to exit along the optical path L2. In this way, the light pulse sequence is scanned along the extension direction X of the second path from the right end of the second path to the left end of the second path during the entire time that the first reflective surface 312 is located on the optical path of the light pulse sequence. The second reflective surface 313 is rotated onto the optical path of the light pulse sequence for the entire time period during which the light pulse sequence is rescanned along the extension direction X of the second path from the right end of the second path to the left end of the second path. The third reflective surface 314 does the same.

Optionally, the drive mechanism in the first scanning module is used to control the reflector to swing back and forth in a stepwise manner, and the drive module in the second scanning module is used to control the rotation of the reflector module in a continuous manner. In this way, the detection apparatus can achieve fast scanning in the second path direction, while ensuring accurate control in the first path direction, and can scan to obtain a multi-row arrangement of point clouds.

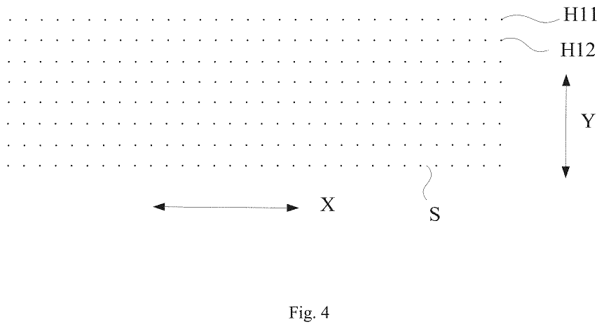

Optionally, as shown in FIG. 4, FIG. 4 is a schematic diagram of an embodiment of the point cloud obtained by scanning of the detection apparatus in an embodiment of the present disclosure. When the reflector stays in one attitude, the light pulse sequence is scanned by the rotation of the reflective module to obtain a point cloud H11 extending along the second path in the extension direction X. When the reflector swings to another attitude, the outgoing light pulse sequence is shifted by a certain distance along the first path in the extension direction Y. During the time period when the reflector stays in this attitude, the light pulse sequence is scanned by the rotation of the reflective module to obtain another point cloud H12 extending along the second path.

Optionally, the field of view of the second scanning module in the extension direction of the second path is larger than the field of view of the first scanning module in the extension direction of the first path. Specifically, as shown in FIG. 4, the light source 10 emits a sequence of light pulses projected onto the detected material in the plane of the beam projection surface S. The detection apparatus 100 can output a plurality of scanning points distributed along the extension direction Y of the first path and along the extension direction X of the second path. Exemplarily, the extension direction Y of the first path is vertical, and the extension direction X of the second path is horizontal.

The detection apparatus 100 can have a field of view (FOV) formed by a plurality of scanning points. For example, the detection apparatus 100 can have a field of view of −M° to M° with respect to the X direction. M° is greater than N°, i.e., the detection apparatus 100 can have a wider field of view with respect to the X direction than with respect to the Y direction. Exemplarily, the detection apparatus 100 can have a field of view of −75° to 75° range in the extension direction X of the second path and a field of view of −15° to 15° range in the extension direction Y of the first path.

Optionally, this can be achieved by the reflective surface in the reflective module in the second scanning module having an angular deflection range for the incident light when rotated greater than the angular deflection range for the incident light when the reflector in the first scanning module is oscillating. In one example, the length of the reflective surface in the reflective module in the direction of extension of the second path is greater than the total swing distance of the reflector in the first scanning module as it oscillates.

That the field of view of the second scan module in the extension direction of the second path is larger than that of the first scan module in the extension direction of the first path, and combined with the continuous driving method in the extension direction of the second path and the stepping driving method in the extension direction of the first path, it can ensure fast scanning in the large-angle field of view direction and accurate scanning in the small-angle field of view direction, which can simultaneously ensure scanning speed and uniform arrangement of the point cloud. General detection apparatus is installed in the application scenario of mobile carriers (such as robots or cars), the field of view requirements in the horizontal direction is large, the field of view requirements in the vertical direction is small, while the speed of the mobile carrier leads to the requirements of the scanning speed of the detection apparatus. Detection apparatus using such a scanning field of view and control mode can be well matched to the needs of these application scenarios. Moreover, it can also avoid the increase in the number of components of the detection apparatus or the increase in the size of the components due to the large field of view in the vertical direction, thus reducing costs.

Moreover, the oscillation of the reflector in the first scanning module is controlled in a stepwise manner, which enables the reflector in the first scanning module to choose the oscillation step, oscillation range, oscillation speed, etc. more flexibly, which makes it easy for the detection apparatus to select the area of interest in the scanning field of view for localized focus scanning, and makes it easy for the detection apparatus to change the resolution flexibly, which are all difficult to achieve with the existing detection apparatus. For example, the swing step of the reflector in the first scanning module can be adjusted. For example, the oscillation range of the reflector in the first scanning module can be adjusted. For example, the oscillation speed of the mirror in the first scanning module can be adjusted.

Optionally, the emission frequency of the light pulse sequence of the light source can be adjusted, combined with the adjustment of the oscillation mode of the reflector. Accordingly, the scanning area and the scanning density of the detection apparatus can be adjusted.

Optionally, the first scanning module is first located on the outgoing optical path of the light pulse sequence, and the light pulse sequence after passing through the first scanning module is then incident to the second scanning module, such a setting order is conducive to the miniaturization of the reflector in the first scanning module, and then the miniaturization of the detection apparatus. The miniaturized reflector is conducive to increasing the oscillation speed of the reflector, and then increasing the scanning speed of the detection apparatus in the extension of the second path, especially in a situation that the scanning angle achieved by the second scanning module is greater than the scanning angle achieved by the first scanning module. In some examples, the detection apparatus of this embodiment has only optical apparatuses such as mirrors and reflective modules in the vertical direction of the optical path, without motors or other non-optical structural parts, thus effectively reducing the size of the detection apparatus along the vertical direction, and thus facilitating the miniaturization of the detection apparatus.

Of course, the order of the first scanning module and the second scanning module on the optical path can also be switched, or, alternatively, the field of view in the direction of the extension of the second path of the first scanning module can be smaller than the field of view in the direction of the extension of the first path, which are not limited here.

Alternatively, the reflector in the first scanning module can be driven not in a stepwise manner, but in a continuous manner. This can increase the scanning speed in the first path direction. This solution can also be used, for example, in some scenes where the uniformity of the point cloud is not so high, or in scenes where the uniformity of the point cloud is high when precise control of the oscillation or rotation of the reflector can be achieved.

Alternatively, the reflective module in the second scanning module can be driven to rotate not in a continuous manner, but in a stepwise manner. This solution can be used for example in scenes where a higher uniformity of the point cloud is required or a lower scanning speed is required in the direction of the extension of the second path.

Exemplarily, the first path is perpendicular to the second path. For example, as shown in FIG. 1, the rotation axis R of the reflective module in the second scanning module may be perpendicular to the oscillation axis B of the reflector in the first scanning module.

In some embodiments, the detection apparatus acquires point cloud data when the reflector moves from a first attitude to a second attitude. When the reflector moves from the second attitude to the first attitude, the detection apparatus does not acquire the point cloud data. This ensures that the point cloud is formed periodically with the same regularity, which helps to form a more uniform and regular point cloud and facilitates the implementation of subsequent processing algorithms for the point cloud.

For example, the light source 10 is used to emit a sequence of light pulses during the time period when the reflector 21 is moving from the first attitude to the second attitude, and the receiver 102 is used to receive or sense the light pulse sequence reflected back by the detected material during the time period when the reflector 21 is moving from the first attitude to the second attitude, and the detection apparatus 100 acquires the point cloud data. The light source 10 is used not to emit the light pulse sequence during the time when the reflector 21 is moving from the second attitude to the first attitude. In this way, the light source 10 can be controlled according to the oscillation of the reflector 21 to ensure that the detection apparatus 100 normal scanning, but also to make full use of the light source 10 to extend the service life of the light source 10.

For example, the light source 10 is used to emit a light pulse sequence during the time when the reflector 21 moves from the first attitude to the second attitude, and the receiver 102 is used to receive or sense the light pulse sequence reflected back by the detected material during the time when the reflector 21 moves from the first attitude to the second attitude, and the detection apparatus 100 acquires the point cloud data. During the time when the reflector 21 moves from the second attitude to the first attitude, the light source 10 has normal emission of light pulse sequence, but the receiver 102 is off, and do not receive or do not sense the light pulse sequence reflected back by the detected material, and accordingly the detection apparatus 100 does not acquire the point cloud data.

Optionally, the time interval of the movement of the reflector 21 from the first attitude to the second attitude is greater than the time interval of the movement from the second attitude to the first attitude. Since the detection apparatus does not acquire point cloud data during the movement of the reflector 21 from the second attitude back to the first attitude, controlling the time interval of the movement of the reflector 21 from the second attitude back to the first attitude is shortened, which can improve the frequency of the detection apparatus to acquire point cloud data. Specifically, the drive mechanism drives the reflector 21 to move from the second attitude to the first attitude at a higher speed than to move from the first attitude to the second attitude, and/or, the number of steps that the drive mechanism drives the reflector 21 to move from the second attitude to the first attitude is less than the number of steps to move from the first attitude to the second attitude. For example, the drive mechanism 22 is used to drive the reflector 21 to swing multiple steps in the same direction from the first attitude to the second attitude, and for driving the reflector 21 to swing one step from the second attitude back to the first attitude.

Exemplarily, the drive mechanism 22 is used to drive the reflector 21 to swing r steps in the same direction from the first attitude to the second attitude. Wherein, r is a natural number greater than 1. For example, r is 10. In some examples, s steps can be selected from the 10 steps, s is less than or equal to r, and s is a natural number, depending on the actual application scenario.

For example, scenario 1: In a scenario where the entire vertical field of view is of interest, the drive mechanism 22 is used to drive the reflector 21 to swing r steps in the same direction from the first attitude to the second attitude, thereby scanning the entire vertical field of view.

For example, scenario 2: In the scenario where only the local vertical direction field of view within the entire vertical direction field of view is of interest, the drive mechanism 22 is used to drive the reflector 21 to oscillate in the range from the i-th step to the j-th step, thereby scanning only the local vertical direction field of view within the entire vertical direction field of view, thereby focusing on the local vertical direction field of view. Where s=j−i and s is less than r, and s is a natural number. For example, i is 1 and j is 5.

For example, scenario 3: in the scenario where the entire vertical field of view is of interest and high-density scanning of the entire vertical field of view is not required, the drive mechanism 22 is used to drive the reflector 21 to swing s steps from the first attitude to the second attitude in the same direction, and compared with scenario 1, the point cloud data obtained has a greater distance between the point cloud rows and the point cloud data is more sparse, which improves the scanning speed and saves the power consumption of the light source and extends the service life of the light source. s is less than r and s is a natural number.

Exemplarily, r and s can be designed according to actual requirements, for example, r is 10 and s is 5.

It can be understood that at least one of scenario 1, scenario 2, and scenario 3 can occur at different detection moments of the detection apparatus 100, without limitation here.

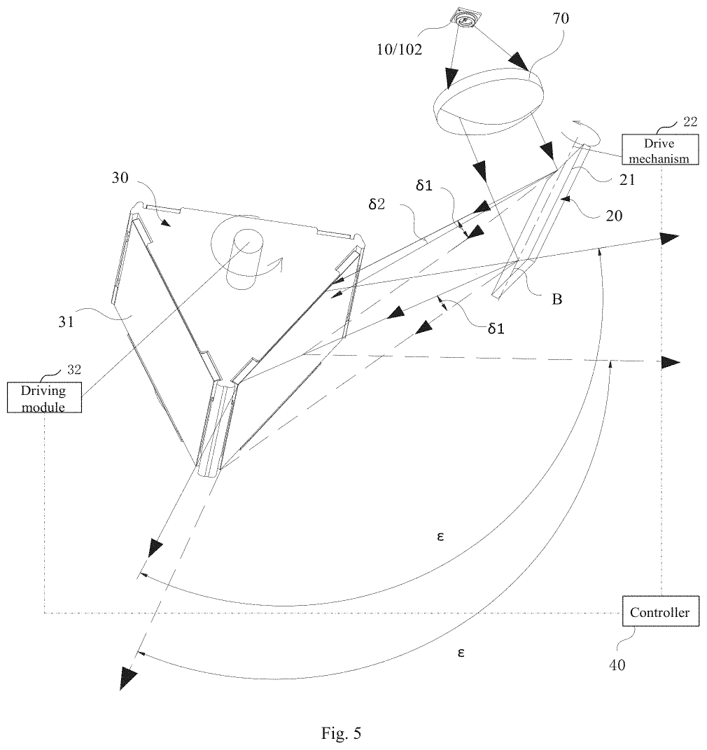

Referring to FIG. 5, exemplarily, the total field of view δ1 of the detection apparatus 100 is the maximum scanning range of the detection apparatus 100 along the vertical direction. The local field of view δ2 is the vertical field of view corresponding to the time when the reflector 21 swings at least one step in the same direction from the first attitude and does not reach the second attitude. The horizontal field of view c is the horizontal field of view when the reflector 21 swings to a predetermined attitude. The predetermined attitude can be a first attitude, a second attitude, or any intermediate attitude between the first attitude and the second attitude.

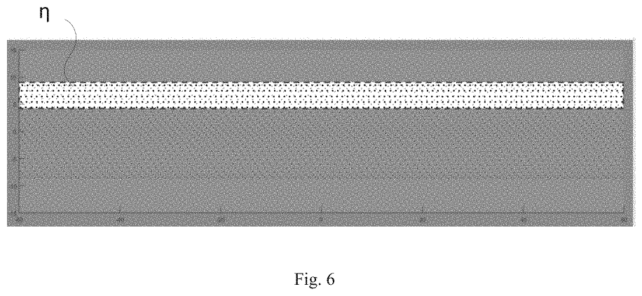

Exemplarily, the detection apparatus 100 can be controlled to perform a high-density scan at a local field of view δ2 corresponding to certain steps of the reflector 21, the results of which are shown as η in FIG. 6.

Exemplarily, the detection apparatus 100 does not acquire point cloud data when the reflector 21 moves from the second attitude to the first attitude. The drive mechanism 22 is used to drive the reflector 21 to swing back from the second attitude to the first attitude in one step.

In some embodiments, multiple blackout periods occur during the rotation of the reflective module 31. The blackout period includes a sum of lengths of time when the edge regions of two adjacent reflective surfaces 311 are on the optical path of the optical pulse sequence, a length of time when an junction regions of two adjacent reflective surfaces 311 are on the optical path of the optical pulse sequence, and lengths of time when the nearest reflective surface 311 of at least two reflective surfaces 311 is substantially parallel to the optical path of the optical pulse sequence.

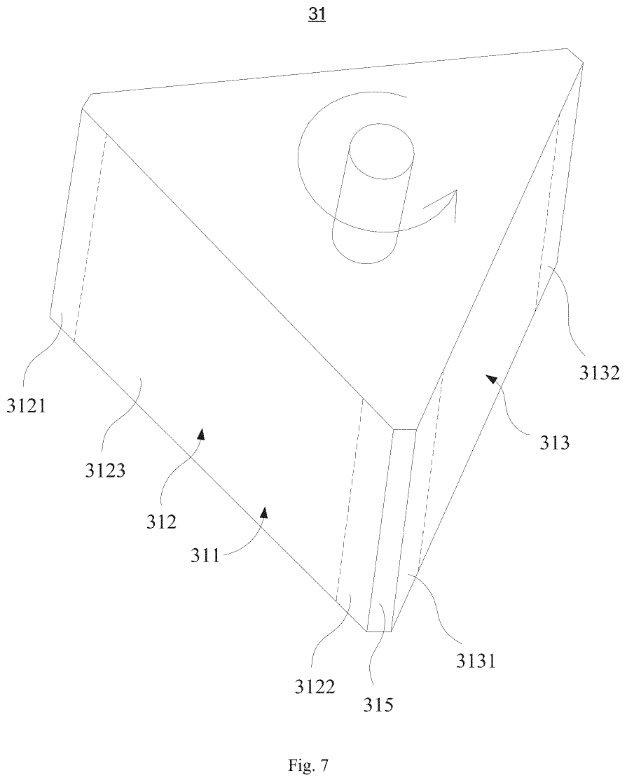

Referring to FIG. 7, exemplarily, the first reflective surface 312 includes a first edge region 3121, a second edge region 3122, and a first intermediate region 3123. The first edge region 3121, the first intermediate region 3123, and the second edge region 3122 are connected sequentially along the direction of rotation of the reflective module 31. The second reflective surface 313 includes a third edge region 3131, a fourth edge region 3132, and a second intermediate region 3133. The third edge region 3131, the second intermediate region 3133, and the fourth edge region 3132 are connected sequentially along the rotational direction of the reflective module 31. Both the second edge region 3122 and the third edge region 3131 are connected to a junction region 315. The second edge region 3122, the junction region 315, and the third edge region 3131 are connected sequentially along the rotation direction of the reflective module 31. When the light pulse sequence is incident to the junction area of the reflective surface and the edge regions near the junction area, the light pulse sequence does not exit the detection apparatus properly due to the large reflection angle.

Exemplarily, the second edge region 3122 of the first reflective surface 312 is located on the optical path of the optical pulse sequence for a duration of t11. The junction area 315 is located on the optical path of the optical pulse sequence for a duration of t12, and the third edge region 3131 of the second reflective surface 313 is located on the optical path of the optical pulse sequence for a duration of t13.

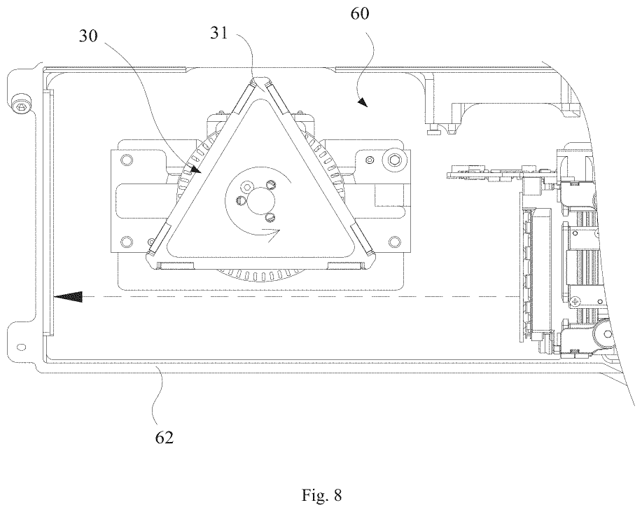

Referring to FIG. 8, the reflective module 31 is rotated until the reflective surface is parallel to the incident light path of the light pulse sequence, and the light pulse sequence fails to be incident to the reflective module 31, but instead is incident across the reflective module 31 to the adjacent side wall of the reflective module 31. The second reflective surface 313 is approximately parallel to the optical path of the light pulse sequence for a duration t14. t0 is equal to the sum of t11, t12, t13 and t14. The blackout time period includes t0.

Exemplarily, the reflective module 31 rotates from a first intermediate region 3123 of the first reflective surface 312 located on the optical path of the optical pulse sequence to a second intermediate region 3133 of the second reflective surface 313 located on the optical path of the optical pulse sequence during one blackout period.

Exemplarily, the number of times a blackout period occurs during rotation of the reflective module 31 may be two, three, or more times. Exemplarily, the number of times a blackout period occurs during the rotation of the reflective module 31 is determined based on the number of reflective surfaces 311 of the reflective module 31. For example, if the number of reflective surfaces 311 of the reflective module 31 is two, two blackout periods occur during one rotation of the reflective module 31. For example, if the number of reflective surfaces 311 of the reflective module 31 is three, three blackout periods occur during the rotation of the reflective module 31.

Exemplarily, the number of times a blackout period occurs during rotation of the reflective module 31 is determined based on the number of junction areas 315 of the reflective module 31. For example, when the number of junction areas 315 of the reflective module 31 is two, two blackout periods occur during rotation of the reflective module 31. For example, if the number of junction areas 315 of the reflective module 31 is three, three blackout periods occur during rotation of the reflective module 31. Exemplarily, the size of the blackout period can be controlled by controlling the rotational speed of the reflective module 31.

Exemplarily, the time period corresponding to the rotation of the first intermediate region 3123 of the first reflective surface 312 or the second intermediate region 3133 of the second reflective surface 313 onto the optical path of the light pulse sequence is the non-blackout vision time period.

In some embodiments, the drive mechanism 22 is used to control the reflector 21 to oscillate during at least a partial number of blackout periods. In this way, the drive mechanism 22 is able to control the reflector 21 to oscillate according to the blackout periods in order to make the scanning trajectory more uniform. In some embodiments, the drive mechanism 22 is used to control the reflector 21 to remain stationary during the non-blackout periods between two adjacent blackout periods. This enables the first path to be scanned along the second path without offset, and the point cloud obtained is uniform and regular, thus improving the ease of feature recognition.

The following is a specific example in conjunction with the point cloud in FIG. 4. Referring to FIG. 4, the reflector 21 remains stationary while the drive module 32 drives the reflective module 31 to rotate to complete the first row of scanning from left to right and scan to the last point of the first row so that the swept row of point clouds can extend along a straight line. The continued rotation of the reflector module 31 enters a blackout period. During the blackout period, the drive mechanism 22 drives the reflector 21 to oscillate at least one step so that the reflector 21 is deflected and the light pulse is deflected to form the first point cloud point of the second row in FIG. 4. The drive module 32 drives the reflective module 31 to continue to rotate, the reflector 21 remains stationary, and the next reflective surface rotates on the outgoing optical path of the light pulse sequence, again completing the second row of scanning from left to right to obtain the second row of point cloud points. And so on.

Optionally, the light source 10 is used to stop emitting light during blackout periods to extend life of the light source. Alternatively, the light source 10 may emit a sequence of light pulses normally during blackout periods to reduce difficulty of controlling the light source.

In some embodiments, the detection apparatus 100 is used to output a point cloud frame sequence based on the scan results. Understandably, the point cloud frame sequence may include at least one frame of point cloud frame. Optionally, each point cloud frame in the point cloud frame sequence comprises a two-dimensional array of point clouds. Exemplarily, the detection apparatus 100 can output a plurality of scanned points distributed along the first path extension direction Y (see FIG. 4) and along the second path extension direction X (see FIG. 4) at each point cloud frame. The plurality of scanned points of each point cloud frame are arranged in an array in the X and Y directions to form a two-dimensional array point cloud. Exemplarily, the extension direction Y of the first path is vertical and the extension direction X of the second path is horizontal. The arrangement of point clouds in a point cloud frame can be as shown in FIG. 4.

Optionally, the drive mechanism 22 is used to drive the reflector 21 to start in the first attitude and end in the second attitude during the sampling duration of each of the two adjacent point cloud frames. This facilitates the similarity of the point cloud arrangement of the two adjacent frames, which in turn facilitates the subsequent algorithmic processing of the point cloud frames. The reflector 21 moves from the first attitude to the second attitude after oscillating in the same direction for a number of steps. Exemplarily, the number of steps may include one step, two steps, three steps, four steps, five steps, or a greater number of steps, without limitation herein.

Exemplarily, the number of steps of deflection required for the movement of the reflector 21 from the first attitude to the second attitude within the sampling duration corresponding to each point cloud frame respectively is determined based on at least one of the number of light sources 10, the field of view size along the extension of the first path, the frame rate, the scan density, the application scenario, etc.

In some embodiments, the drive mechanism 22 is used to drive the reflector 21 to start in a first attitude and end in a second attitude, and the reflector 21 to move from the first attitude to the second attitude after oscillating a number of steps in the preset oscillation direction, respectively, during the sampling duration corresponding to each of the two adjacent point cloud frames; the drive mechanism 22 is used to drive the reflector 21 to start in a second attitude and end in a first attitude, and the reflector 21 to move from the second attitude to the first attitude after oscillating a number of steps in the direction opposite to the preset oscillation direction. The reflector 21 is driven to start in the second attitude and end in the first attitude, and the reflector 21 is moved from the second attitude to the first attitude after oscillating a number of steps in the direction opposite to the preset oscillation direction.

Exemplarily, the first attitude may be the attitude corresponding to the first row of the point cloud in the two-dimensional array of point clouds. The second attitude may be the attitude corresponding to the last row of the point cloud rows in the two-dimensional array of point clouds.

Exemplarily, the first attitude may be the attitude corresponding to the last row of the point cloud rows in the two-dimensional array of point clouds. The second attitude is the attitude corresponding to the first row of the point cloud in the two-dimensional array of point clouds.

In some embodiments, the drive mechanism 22 is used to control the reflector 21 to oscillate during each blackout period that occurs within a point cloud frame to make the scan trajectory more uniform.

In some embodiments, the time gap at the junction of two adjacent point cloud frames lies within the blackout period of the detection apparatus 100.

Exemplarily, the time gap at the junction of two adjacent point cloud frames comprises the time gap between switching from the last point of one point cloud frame to the first point of another adjacent point cloud frame.

In some embodiments, the drive mechanism 22 is used to drive the reflector 21 to oscillate during the blackout period of the detection apparatus 100. In this way, the oscillation of the reflector 21 can be prevented from affecting the scanning of the outgoing beam along the second path.

In some embodiments, the reflector 21 is capable of oscillating at least one step when the detection apparatus 100 is switched from one point cloud row to another.

Exemplarily, the first path extends along the vertical direction and the second path extends along the horizontal direction. Each point cloud frame includes a number of point cloud rows. The point cloud rows extend horizontally. The drive mechanism 22 can drive the reflector 21 to swing at least one step before one point cloud row scan ends and another adjacent point cloud row scan begins.

In some embodiments, the reflector 21 is capable of oscillating at least one step when the detection apparatus 100 switches from one scan frame to another.

Exemplarily, the first path extends in the vertical direction and the second path extends in the horizontal direction. The point cloud frame sequence includes a plurality of point cloud frames. The drive mechanism 22 can drive the reflector 21 to swing at least one step during an interval from the last point of one point cloud frame to the first point of another adjacent point cloud frame.

In some embodiments, there is an overlap between the duration of the frame change and the duration of the switch of the reflector 21 from the second attitude to the first attitude.

Exemplarily, the duration of the frame change is the length of time between the last point of a point cloud frame and the first point of another adjacent point cloud frame.

Exemplarily, the duration of the frame change is at least partially coincident with the duration of the switch from the second attitude to the first attitude of the reflector 21. For example, the duration of the frame change is slightly less than the duration of the switch from the second attitude to the first attitude of the reflector 21. For example, the duration of the frame change is equal to the duration of the switch from the second attitude to the first attitude of the reflector 21. For example, the duration of the frame change is slightly greater than the duration of the switch from the second attitude to the first attitude.

Exemplarily, when the detection apparatus 100 scans to the last point of a point cloud frame, the drive mechanism 22 drives the reflector 21 to swing at least one step to move the reflector 21 from a second attitude to a first attitude. After the reflector 21 moves to the first attitude, the detection apparatus 100 then scans the first point of another adjacent point cloud frame.

In some embodiments, the blackout period is greater than or equal to the switching duration of the point cloud rows of the detection apparatus 100. In this way, it is possible to ensure that the blackout periods appear between point cloud rows, while reducing the possibility of the blackout period within a point cloud row.

In some embodiments, the blackout period is greater than or equal to the switching duration of the point cloud frames of the detection apparatus 100. In this way, it is possible to ensure that the blackout periods occur between point cloud frames, while reducing the occurrence of blackout periods within one point cloud row of a point cloud frame.

In some embodiments, the drive mechanism 22 drives the reflector 21 from the second attitude to the first attitude for a period of time less than or equal to the blackout period. For example, the length of time that the reflector 21 moves from the second attitude to the first attitude is less than the blackout period. For example, the length of the movement of the reflector 21 from the second attitude to the first attitude is equal to the blackout period. For example, the length of the movement of the reflector 21 from the second attitude to the first attitude is slightly greater than the blackout period.

In some embodiments, the reflector 21 oscillates for at least one step during the blackout period. The reflector 21 remains stationary during the non-blackout vision period between two adjacent blackout periods.

Understandably, the speed at which the drive mechanism 22 drives the oscillation of the reflector 21, and the speed at which the drive module 32 drives the rotation of the reflective module 31 can be designed according to actual needs.

In some embodiments, the drive mechanism 22 is used to drive the reflector 21 to oscillate at an even speed and the drive module 32 is used to drive the reflector module 31 to rotate at an even speed.

In some embodiments, the drive mechanism 22 is used to communicate with the drive module 32 to control the oscillation of the reflector 21 based on the rotation angle of the reflective module 31. For example, the drive module 32 is used to detect the rotation angle of the reflective module 31 in real time and send that rotation angle to the drive mechanism 22 so that the drive mechanism 22 can control the oscillation of the reflector 21 based on that rotation angle. For example, the drive mechanism 22 may determine whether it is currently a blackout period based on this rotation angle to control the oscillation of the reflector 21 during the blackout period. For example, the drive module 32 is used to detect the rotation angle of the reflective module 31 and, when it is determined that it is a blackout period, send a control command to the drive mechanism 22 so that the drive mechanism 22 can control the oscillation of the reflector 21 according to the control command.

Exemplarily, as shown in FIG. 3, the second scanning module 30 also includes a photoelectric code disk 33 and a photoelectric switch for detecting the rotation angle information of the reflective module 31 to enable the reflector 21 to control the movement of the reflector 21 based on this rotation angle information.

Referring to FIG. 5, in some embodiments, the detection apparatus 100 further includes a control unit or controller 40. The control unit is used to control the operation of the first scanning module 20 and the second scanning module 30. Exemplarily, the control unit is electrically connected to the drive mechanism 22 and the drive module 32 for controlling the drive mechanism 22 to drive the reflector 21 to oscillate and the drive module 32 to drive the reflective module 31 to rotate. In other embodiments, both the drive mechanism 22 and the drive module 32 are capable of communicating with the control unit 40. The drive mechanism 22 is able to send the rotation angle of the reflective module 31 to the control unit 40 so that the control unit 40 controls the drive mechanism 22 to drive the reflector 21 to oscillate based on the rotation angle of the reflective module 31. In some embodiments, the first scanning module 20 is used to communicate with the drive module 32 to control the reflector 21 to swing at least one step based on the rotation angle of the reflective module 31.

Understandably, the angle between each reflective surface 311 of the reflective module 31 and the rotation axis of the reflective module 31 can be designed to any suitable angle according to practical needs. Referring to FIG. 8, in some embodiments, the reflective surface 311 is parallel to the axis of rotation of the reflective module 31.

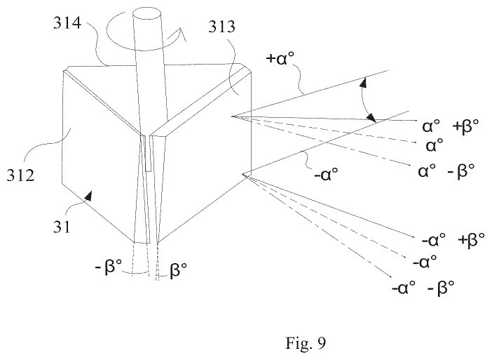

Referring to FIG. 9, in some embodiments, the reflective surface 311 is non-parallel to the rotation axis of the reflective module 31. In this way, the second scanning module 30 can not only make the outgoing beam along the second path scanning, but also with the first scanning module 20 together to make the outgoing beam along the first path scanning, thereby reducing the size of the first scanning module 20 along the vertical direction and accordingly reducing the size of the detection apparatus 100 along the vertical direction, which is conducive to the miniaturization of the detection apparatus 100. It can be understood that in the case of a fixed size of the reflector 21 along the vertical direction, the reflective surface 311 is non-parallel to the rotation axis of the reflective module 31, which can increase the field of view of the detection apparatus 100 in the vertical direction.

Exemplarily, the rotation axis of the reflective module 31 is set non-parallel to at least one of the at least two reflective surfaces 311.

Exemplarily, the angle between each of the at least two reflective surfaces 311 and the rotation axis of the reflective module 31 may be the same, partially the same or different from each other.

Referring to FIG. 9, exemplarily, the reflective module 31 includes a first reflective surface 312, a second reflective surface 313, and a third reflective surface 314. The angle between the first reflective surface 312 and the rotation axis of the reflective module 31 is −β°, the angle between the second reflective surface 313 and the rotation axis of the reflective module 31 is β°, and the third reflective surface 314 is parallel to the rotation axis of the reflective module 31. The optical pulse sequence passing through the first scanning module 20 has a field of view of ±α° in the direction of extension along the first path, i.e., in the range between −α° and α° (both −α° and α° inclusive).

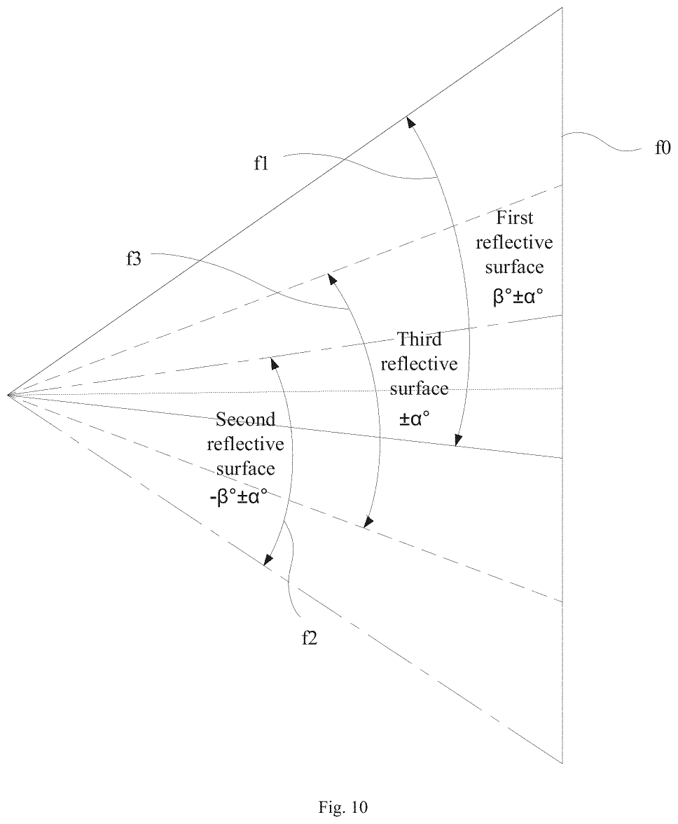

Referring to FIG. 10, since the angle between the first reflective surface 312 and the rotation axis of the reflective module 31 is −β°, the first subfield of view in the vertical direction of the light pulse sequence emitted from the first scanning module 20 after exiting through the first reflective surface 312 is β°±α°, i.e., in the range between β°+α° and β°−α° (both β°+α° and β°−α° inclusive).

Since the angle between the second reflective surface 313 and the rotation axis of the reflective module 31 is β°, the second subfield of view of the light pulse sequence from the first scanning module 20 in the vertical direction after passing through the second reflective surface 313 is β°±α°, i.e., in the range between −β°+α° and −β°−α° (both β°+α° and β°−α° inclusive).

Since the third reflecting surface 314 is parallel to the rotation axis of the reflecting module 31, i.e., the angle between the third reflecting surface 315 and the rotation axis of the reflecting module 31 is 0°, the third subfield of view in the vertical direction after the light pulse sequence from the first scanning module 20 passes through the third reflecting surface 315 is ±α°.

Understandably, both α° and β° can be designed according to actual needs and are not limited here.

Exemplarily, referring to FIG. 10, the vertical field of view corresponding to the first reflective surface 312 is the first subfield of view f1, the vertical field of view corresponding to the second reflective surface 313 is the second subfield of view f2, and the vertical field of view corresponding to the third reflective surface 314 is the third subfield of view f3. The vertical field of view corresponding to the reflective module 31 is the total field of view f0.

The total field of view f0 is determined based on the first subfield f1, the second subfield f2 and the third subfield f3.

Exemplarily, at least two of the first subfield of view f1, the second subfield of view f2, and the third subfield of view f3 are overlapping.

Exemplarily, the distribution of the outgoing beam in the vertical direction can be adjusted to obtain a higher beam density in the central region by adjusting the angle between each reflective surface in the reflective module and the rotation axis.

In some embodiments, the angle between the reflective surface 311 and the rotation axis of the reflective module 31 is an acute angle. For example, the angle between at least one of the at least two reflective surfaces 311 and the axis of rotation of the reflective module 31 is greater than 0° and less than or equal to 30°.

Understandably, the number of reflective surfaces 311 of the reflective module 31 can be designed according to practical needs, such as two, three, four, or more. Compared with only one reflective surface 311 of the reflective module 31, a reflective module 31 including at least two reflective surfaces 311 can increase density of scanned point clouds per unit time at the same rotational speed.

The number of reflective surfaces 311 of the reflective module 31 decreases, and the blackout period will be extended accordingly. The number of reflective surfaces 311 of the reflective module 31 increases, and the field of view in the extended direction of the second path decreases accordingly. Exemplarily, the number of reflective surfaces 311 of the reflective module 31 is controlled to satisfy the condition that the blackout periods occur between point cloud rows and do not occur within a single point cloud row.

Referring to FIG. 3 or FIG. 8, in some embodiments, the reflective module 31 includes three reflective surfaces 311. Exemplarily, the number of reflective surfaces 311 of the reflective module 31 is three, so as to enable a relatively short blackout period, but also to obtain a large field of view in the direction of the extension of the second path, and not to have a blackout period within a point cloud row.

In some embodiments, at least some of the reflective surfaces in the reflective module have different angles to the rotation axis of the reflective module, respectively.

In some embodiments, one of the at least two reflective surfaces has an angle of +β degrees with the rotation axis of the reflective module and one of the reflective surfaces has an angle of −β degrees with the rotation axis of the reflective module, where β is a value greater than 0.

In some embodiments, the number of the at least two reflective surfaces is 3 and the third reflective surface is parallel to the axis of rotation of the reflective module.

Referring to FIG. 3, in some embodiments, at least two reflective surfaces 311 are connected end to end and are provided around the axis of rotation of the reflective module 31.

Exemplarily, at least two reflective surfaces 311 are spaced around the rotation axis of the reflective module 31.

Exemplarily, the at least two reflective surfaces 311 may be provided symmetrically about the rotation axis of the reflective module 31, or they may be provided asymmetrically. For example, the at least two reflective surfaces 311 are set center-symmetrically or rotationally symmetrically about the rotation axis of the reflective module 31.

The dimensions between each of the at least two reflective surfaces 311 may be the same, partially the same, or different from each other.

The shape of the reflective surface 311 can be designed according to the actual needs, exemplarily, the shape of the reflective surface 311 including square, oval, etc., so as to meet the light path design needs, but also to minimize the waste of materials and reduce costs.

Exemplarily, the angle between the oscillation axis of the reflector 21 and the rotation axis of the reflector module 31 is an acute angle, an obtuse angle, or a right angle. Exemplarily, the angle between the oscillation axis of the reflector 21 and the rotation axis of the reflector module 31 is 90°.

In some embodiments, the light source 10 includes a plurality of laser units.

Exemplarily, the plurality of laser units can be arranged according to the scanning form of the detection apparatus 100, for example, in a single row. For example, a plurality of laser units are arranged in multiple rows in a certain geometric relationship.

Exemplarily, the light source 10 includes one or more diodes, such as a laser diode. Exemplarily, the light source 10 includes a laser diode by which laser pulses are emitted at nanosecond levels. Further, the laser pulse reception time may be determined, for example, by detecting the rising edge time and/or the falling edge time of the electrical signal pulse to determine the laser pulse reception time. In this way, the detection apparatus 100 can use the pulse reception time information and the pulse emission time information to calculate the TOF and thereby determine the distance from the detection object to the detection apparatus 100.

In some embodiments, the light source 10 is a single-line laser. In some embodiments, the light source 10 is a multi-line laser. Exemplarily, the multi-line laser includes a plurality of line count laser units, where the spatial locations of the sequences of light pulses emitted by the individual line count laser units do not overlap.

Exemplarily, the light source 10 is a multi-line laser. A plurality of laser units are used to emit light sequentially. For example, the plurality of laser units emits light sequentially based on the order of the position of the plurality of laser units. In some embodiments, the plurality of laser units are used to emit light simultaneously, without limitation herein.

In some embodiments, the lines of the light spots formed by the plurality of laser units on the reflective surface of the reflective module, respectively, are not parallel to the trajectory of the light spots moving on the rotating reflective surface when the reflective surface of the reflective module is rotated.

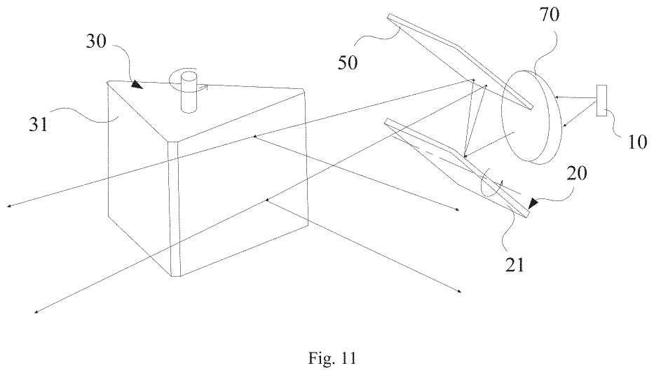

Referring to FIG. 11, in some embodiments, the detection apparatus 100 also includes a reflecting element 50. The first scanning module 20, the reflecting element 50 and the second scanning module 30 are provided in sequence along the optical path of the light pulse sequence of the light source 10 for changing the propagation direction of the light pulse sequence emitted from the first scanning module 20. The light path between the first scanning module 20 and the second scanning module 30 can be compressed by the setting of the reflecting element 50, which facilitates the miniaturization of the detection apparatus. Moreover, the setting of the reflecting element 50 can reduce the vibration angle of the first scanning module 20 while ensuring the deflection angle of the light beam. In some examples, the reflecting element 50 includes a reflective element. In some examples, the detection apparatus 100 may also include a drive mechanism for driving the reflecting element 50 to swing in a fixed swing axis. The oscillation of the reflecting element 50 may be the same as or different from the oscillation of the reflector in the first scanning module 20.

Referring to FIG. 1, the detection apparatus 100 may also include a collimating element 70 for collimating the light pulse sequence emitted by the light source 10. The collimating element 70 and the first scanning module 20 are provided sequentially along the optical path of the light pulse sequence of the light source 10 for collimating the light pulse sequence emitted by the light source 10.

Exemplarily, the collimating element 70, the first scanning module 20 and the second scanning module 30 are provided sequentially along the optical path of the light pulse sequence of the light source 10.

In some embodiments, the optical axis of the collimating element 70 is parallel to the oscillation axis of the reflector 21. Exemplarily, the optical axis of the collimating element 70 coincides with the oscillation axis of the reflector 21.

In some embodiments, the optical axis of the collimating element 70 is non-parallel to the oscillation axis of the reflector 21. For example, the angle between the optical axis of the collimating element 70 and the oscillation axis of the reflector 21 is acute, obtuse, or right angles.

Exemplarily, the optical axis of the collimating element 70 is perpendicular to the axis of oscillation of the reflector 21.

The shape of the collimating element 70 can be designed according to the shape of the target scan track and/or the light bar. For example, the shape of the collimating element 70 includes a circle, an ellipse, or a square, etc. If the shape of the target scan track is square and the shape of the light bar is square, the shape of the collimating element is also designed to be square. Exemplarily, the collimating element 70 includes a collimating lens.

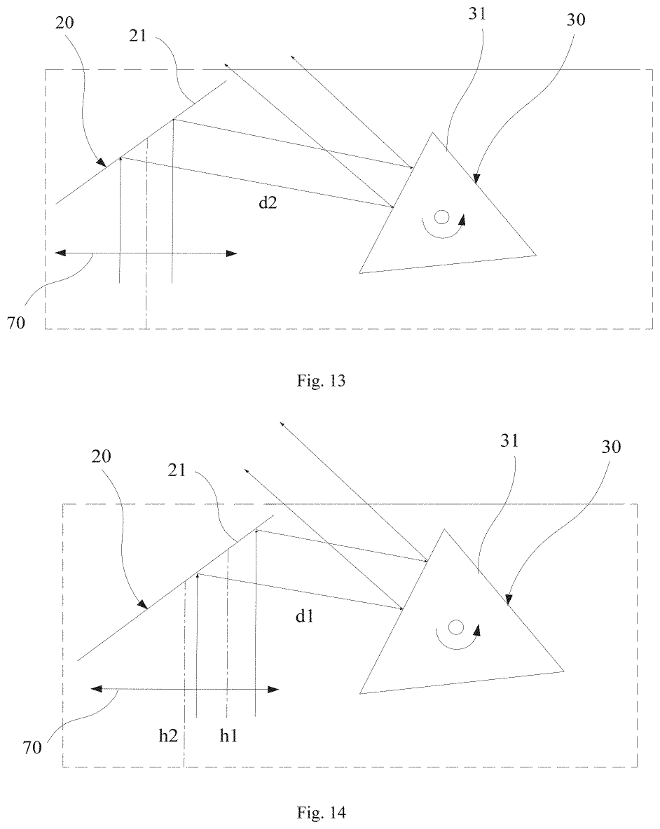

Referring to FIG. 13, exemplarily, the optical axis of the sequence of light pulses incident to the first scanning module 20 coincides with the optical axis of the collimating element 70.

Referring to FIG. 14, in some embodiments, the spot formed by the outgoing beam of the light source on the collimating element is off-center of the collimating element.

In some embodiments, the spot formed by the outgoing beam of the light source on the collimating element is deflected away from the center of the collimating element towards the side of the collimating element near the reflective module.

In some embodiments, the axis of oscillation of the reflector in the first scanning module is perpendicular to the axis of rotation of the reflective module in the second scanning module.

Referring to FIG. 14, the optical axis of the light pulse sequence incident to the first scanning module 20 is parallel to the optical axis of the collimating element 70, and the optical axis of the light pulse sequence incident to the first scanning module 20 is offset from the optical axis of the collimating element 70 toward the second scanning module 30. Comparing FIG. 13 and FIG. 14, it can be seen that the distance d1 of the optical path between the first scanning module 20 and the second scanning module 30 in FIG. 14 is smaller than the distance d2 of the optical path between the first scanning module 20 and the second scanning module 30 in FIG. 13. Thus, the layout design in FIG. 14 can reduce the size of the detection apparatus 100 and facilitate the miniaturization of the detection apparatus 100.

Referring to FIG. 14, exemplarily, the optical axis h1 of the light pulse sequence incident to the first scanning module 20 is parallel to the optical axis h2 of the collimating element 70, and the optical axis h1 is offset from the optical axis h2 of the collimating element 70. Exemplarily, the optical axis h1 is offset from the optical axis h2 of the collimating element 70 in a direction proximate to the reflective module 31.

Referring to FIG. 8, in some embodiments, the detection apparatus 100 also includes a housing 60 in which the light source 10, the first scanning module 20, and the second scanning module 30 are located. The housing 60 includes a light-blocking section 61 and a light-transmitting section 62 for the light pulse sequence to pass through. The light-blocking section 61 is connected to the light-transmitting section 62.

Exemplarily, when the reflective surface 311 is rotated onto the optical path of the light pulse sequence, the light pulse sequence can be projected from the light-transmitting segment 62 to the external environment. When the reflective module 31 is rotated to a certain angle (e.g., one reflective surface 311 of the reflecting module 31 is parallel to the optical axis of the light pulse sequence emitted from the first scanning module 20), at least part of the light pulse sequence is projected onto the housing 60. At this time, if the reflectivity of the corresponding part of the housing 60 is larger, it is able to reflect the light pulse sequence.

Assuming that the time required for the light pulse sequence reflected by the housing 60 to reach the receiver is t21, and the time required for the light pulse sequence reflected by the detected material closer to the radar to reach the receiver is t22. The difference between t21 and t22 is small, thus affecting the accuracy of the close-range detection of the detection apparatus 100.

For this reason, the light-blocking section 61 of one embodiment is able to attenuate the possibility of reflecting light pulse sequences from the housing 60 and improve the accuracy of the detection apparatus 100 at close range.

Exemplarily, the light-blocking section 61 is connected to the light-transmitting section 62 to form a side wall of the housing 60. The bottom wall, the top wall and side walls of the housing 60 cooperate to form a housing cavity. The bottom wall and the top wall of the housing 60 are provided at opposite ends of the side walls. The light source 10, the first scanning module 20 and the second scanning module 30 are housed in the cavity.

Exemplarily, the surface of the light-blocking section 61 toward the side of the housing cavity may be provided with a coating or material layer having a low reflectivity.

Exemplarily, the light-blocking segment 61 is connected to the light-transmitting segment 62 to form an annular sidewall.

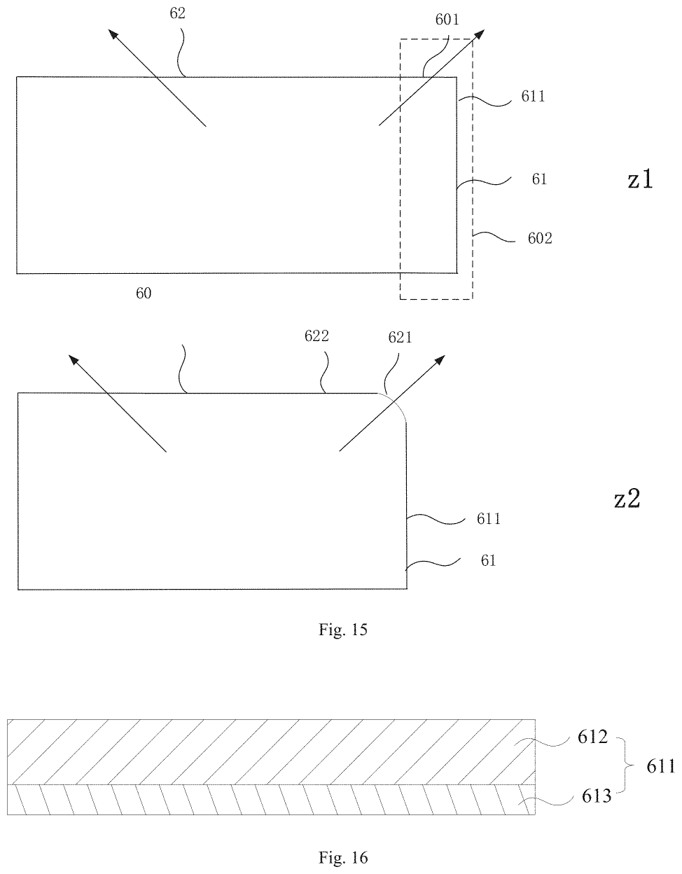

Referring to FIG. 15, in some embodiments, the light-blocking segment 61 includes a low-reflectivity wall 611. The low-reflectivity wall 611 is connected to the light-transmitting segment 62. When the second scanning module 30 is not located on the optical path of the light pulse sequence, the low-reflectivity wall 611 can attenuate the reflection of the light pulse sequence projected to the light-blocking segment 61. In this way, the possibility of reflecting the light pulse sequence from the light-blocking segment 61 can be reduced, thus improving the accuracy of the detection apparatus 100 at close range.

Referring to FIG. 16, in some embodiments, the low-reflectivity wall 611 includes a wall body 612 and a low-reflectivity layer 613. The low-reflectivity layer 613 is provided on the side of the wall body 612 facing the light source 10. In this way, the light-transmitting section 62 can be processed easily and the cost of the light-transmitting section 61 can be reduced, provided that the light-reflecting pulse sequence of the light-transmitting section 61 is reduced.

Exemplarily, the wall body 612 is fixedly connected to the light-transmitting segment 62. The low-reflectivity layer 613 is made of a low-reflectivity material.

Exemplarily, the light-transmitting segment 62 is made of a material capable of transmitting light, for example, made of glass, plastic with light-transmitting properties, and other materials.

In some embodiments, the low-reflectivity wall 611 is made of a low-reflectivity material that is fixedly connected to the light-transmitting segment 62.

The surface of the detection apparatus 100 comprises a first surface and a second surface intersecting each other, the light-blocking segment 62 being located on the first surface.

Referring to the lower portion of FIG. 15, the light-transmitting segment 62 includes a first light transmitting zone 621 and a second light transmitting zone 622. The first light transmitting zone 621 is disposed at the junction of the first surface and the second surface, extending from one end of the light-blocking segment bent to the second surface. The second light-transmitting zone is disposed on the second surface, the second light-transmitting zone being connected to the other end of the first light-transmitting zone.

In other embodiments, the second light-transmitting zone 622 may also be provided coplanar with the first light-transmitting zone 621.

Exemplarily, the arrows in FIG. 15 indicate a light pulse sequence. The light pulse sequence is emitted from the light-transmitting segment 62.

It will be appreciated that, referring to FIG. 15, two design options for the light-transmitting segment 62 are illustrated in FIG. 15, option z1 and option z2, respectively. in option z1, the light-transmitting segment 62 is planar, i.e., the first light-transmitting zone 621 is coplanar with the light-transmitting body 601. In scheme z2, the second light-transmitting zone 622 is bent and extended from one end of the first light-transmitting zone 621.

In order to ensure that the light pulse sequence can be properly emitted, option z1 requires an additional area 602 than option z2. Thus, the detection apparatus 100 of option z2 can reduce the size of the housing 60 compared to option z1, which facilitates the miniaturization of the detection apparatus 100.

It will be appreciated that the second light-transmitting zone 622 may be any suitable shape. Referring to FIG. 15, exemplarily, the first light-transmitting zone 621 is non-co-planar with the second light-transmitting zone 622; and the second light-transmitting zone 622 is non-co-planar with the part of the light-blocking segment 61 used to connect to the second light-transmitting zone 622. Exemplarily, the first light-transmitting zone comprises a smooth curved surface or a flat surface.

Exemplarily, the first light-transmitting zone 621 is chamfered with the part of the light-blocking section 61 used to connect to the second light-transmitting zone 622. Exemplarily, the first light-transmitting zone 622 includes a rounded surface or an elliptical surface, etc.

Exemplarily, the detection apparatus includes also a receiver. The receiver can detect the detected material based on receiving the reflected beam. Exemplarily, the receiver is used to receive the reflected beam reflected by the detected material and convert the reflected beam into an electrical signal for determining the distance between the detected material and the detection apparatus.

Exemplarily, the receiver includes a single sensing element for detecting the reflected beam 113. For example, the receiver includes a single pixel receiver.

In some embodiments, the detection apparatus 100 may employ a coaxial or co-axial optical path scheme. Exemplarily, the reflected beam 113 and the light pulse sequence emitted by the light source 10 (e.g., emitted beam 111, outgoing beam 112) may share at least part of the optical path within the detection apparatus 100. Exemplarily, the collimating element 70 is also used to guide the reflected beam to the receiver.

In some embodiments, the detection apparatus 100 may also be based on a dual-axis scheme, for example, without limitation here, when the reflected beam 113 and the light pulse sequence emitted by the light source 10 (e.g., emitted beam 111, outgoing beam 112) may be configured to travel along different light paths.

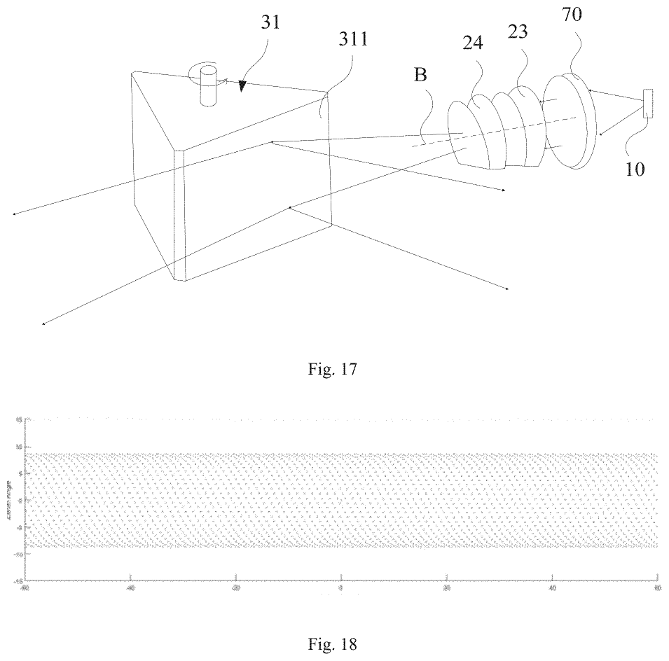

The detection apparatus in which the first scanning module includes a double prism and a drive mechanism for driving the rotation of the double prism, and the second scanning module includes a reflective module having at least two reflective surfaces and a drive module for driving the rotation of the reflective module are explained in detail below in connection with FIG. 17. It should be noted that the first scanning module is described hereinafter mainly by way of example, and details of other aspects of the detection apparatus can be found in the description of the detection apparatus above.

Referring to FIG. 17, the detection apparatus 100 includes a light source 10, a first scanning module 20 and a second scanning module 30. The light source 10 is used to emit a sequence of light pulses, such as a sequence of laser pulses. The first scanning module 20 and the second scanning module 30 are provided in turn on the optical path of the light pulse sequence, respectively, for changing the propagation direction of the light pulse sequence in turn. The description of the light source 10 and the second scanning module 30 can be found above and will not be repeated here.

In some embodiments, the first scanning module 20 includes a drive mechanism 22, a first prism 23, and a second prism 24. wherein both the first prism 23 and the second prism 24 have two surfaces that are not parallel. The first prism 23 and the second prism 24 are provided sequentially along the optical path of the light pulse sequence of the light source 10. The drive mechanism 22 is capable of driving the first prism 23 and the second prism 24 to rotate.

Exemplarily, the sequence of light pulses passes sequentially through the first prism 23 and the second prism 24.

Exemplarily, the sequence of light pulses passes sequentially through the first prism 23, the second prism 24 and the reflective module 31.

Understandably, the direction of rotation of the first prism 23 and the direction of rotation of the second prism 24 may be the same or different. For example, the direction of rotation of the first prism 23 is opposite to the direction of rotation of the second prism 24. The rotational speed of the first prism 23 and the rotational speed of the second prism 24 may be the same or different. The first prism 23 and/or the second prism 24 may rotate at a uniform speed, or at a variable speed, without limitation herein. For example, the first prism 23 and/or the second prism 24 may rotate at a low speed when the vertical scanning angle is 0° and at a high speed when the vertical scanning angle is maximum or minimum, resulting in a higher scanning density when the vertical scanning angle is 0°. Exemplarily, the first prism 23 is rotated at a uniform or variable speed; and/or, the second prism 24 is rotated at a uniform or variable speed. In some embodiments, the drive mechanism 22 is driven by at least one of an electrostatic drive method, an electromagnetic drive method, a piezoelectric drive method, or a thermoelectric drive method, etc.

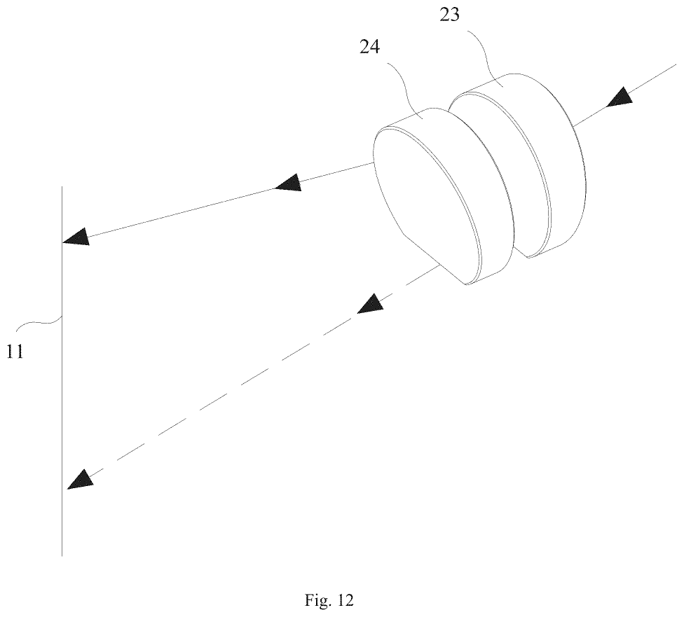

As shown in FIG. 12, the drive mechanism 22 is used to control the first prism 23 and the second prism 24 to rotate in reverse at the same speed. The combination of the first prism and the second prism rotating at the same speed in opposite directions alone allows the light pulse sequence to be repeatedly scanned back and forth along the first path 11. Understandably, in practice, it is difficult to control the two prisms at strictly the same speed, so the rotation speed of the first prism and the second prism may drift a little during the rotation process, resulting in the scanned trajectory being not strictly a straight line, but a little curved, but still generally straight.

Exemplarily, refer to FIG. 17, which is a schematic diagram of the scanning trajectory obtained by the drive mechanism 22 driving the first prism and the second prism to rotate at 300 rpm at an equal speed in reverse and the drive module 32 driving the reflective module 31 to rotate at 6000 rpm at an equal speed.

In some embodiments, the drive mechanism 22 is used to drive the first prism and the second prism to rotate at variable speeds while maintaining reverse rotation at the same speed, and the drive module 32 is used to drive the reflective module 31 to rotate at an even speed to make the scanning density as uniform as possible.

In some embodiments, the drive mechanism 22 is used to drive the first prism and the second prism to rotate at a sinusoidal variable speed while maintaining reverse rotation at the same speed, which can further make the scanning density more uniform.

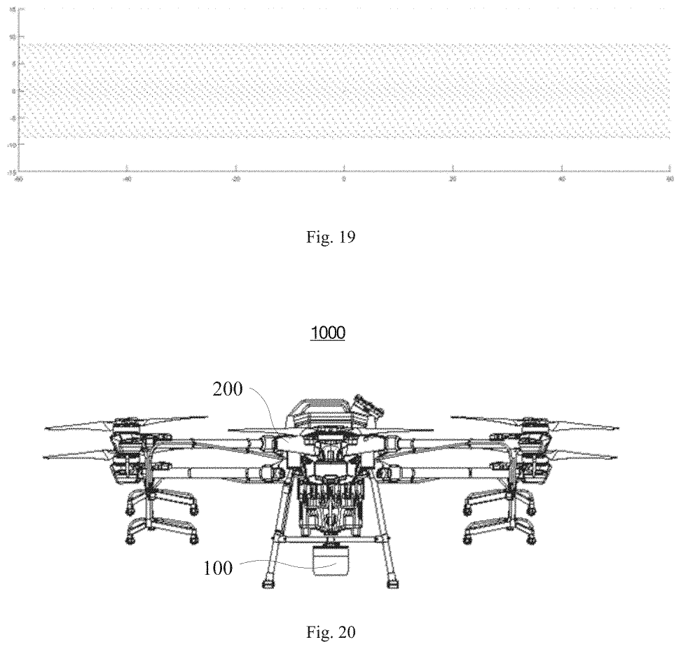

Exemplarily, refer to FIG. 18, which is a schematic diagram of the scan trajectory obtained by the drive mechanism 22 driving the first prism and the second prism to rotate at the same speed in reverse rotation while rotating at a sinusoidal variable speed, and the drive module 32 driving the reflective module 31 to rotate at 6000 rpm. As can be seen in FIG. 18, the scan density corresponding to a vertical scan angle of 0° is less different from that corresponding to a vertical scan angle of 9° or −9°, and the uniformity of the point cloud in FIG. 18 is improved compared with that of the point cloud in FIG. 19.

It will be understood that reflecting element, reflective surface, and reflector all refer to elements capable of reflecting light beams, and are herein described only for ease of explanation and are not limited thereby. The drive mechanism and the drive module refer to the module that can drive the movement of the optical element, and are used herein for the purpose of explanation only and are not limited accordingly.

Some embodiments of the present application also provide a scanning unit comprising a first scanning module and a second scanning module. The first scanning module and the second scanning module are provided in the optical path of the light pulse sequence emitted by the light source, wherein the first scanning module is used to change the propagation direction of the light pulse sequence so that the outgoing light beam is scanned along the first path. The second scanning module comprises a reflecting module and a driving module, the reflecting module comprising at least two reflecting surfaces, the driving module being used to drive the reflecting module to rotate the at least two reflecting surfaces so that the at least two reflecting surfaces are rotated sequentially onto the optical path of the light pulse sequence to cause the scanning unit to form a scan in a two-dimensional direction.

Exemplarily, the first scanning module and the second scanning module may refer to the first scanning module and the second scanning module of any of the above embodiments and will not be described herein.

Exemplarily, the detection apparatus includes a light source and a scanning unit of the above embodiment. The detection apparatus can refer to the detection apparatus of any of the above embodiments and will not be repeated here.

Referring to FIG. 20, some embodiments of the present application provide a movable platform 1000 including a platform body 200 and a detection apparatus 100 of any of the above embodiments.

Understandably, the distance and/or orientation detected by the detection apparatus 100 may be applied in spatial scene simulation, automatic obstacle avoidance systems, 3D imaging systems, 3D modeling systems, remote sensing systems, mapping systems, navigation systems, and other settings. In one implementation, the detection apparatus 100 may be applied to the movable platform 1000, and the detection apparatus 100 may be mounted on the platform body 200 of the movable platform 1000. the movable platform 1000 including the detection apparatus 100 may measure the external environment, for example, measure the distance of the movable platform 1000 from an obstacle for purposes such as obstacle avoidance, and perform 2D or three-dimensional mapping of the external environment. In some implementations, the movable platform 1000 includes at least one of an unmanned aerial vehicle, a car, a ship, a remotely operated vehicle, a robot, a camera, etc. When the detection apparatus 100 is applied to an unmanned aerial vehicle, the platform body 200 is the fuselage of the unmanned aerial vehicle. When the detection apparatus 100 is applied to a car, the platform body 200 is the body of the car. The car can be an autopilot car or a semi-autopilot car, which is not limited here. When the detection apparatus 100 is applied to a remotely controlled car, the platform body 200 is the body of the remotely controlled car. When the detection apparatus 100 is applied to a robot, the platform body 200 is the robot. When the detection apparatus 100 is applied to a camera, the platform body 200 is the camera itself.

Some embodiments of the present application also provide a movable platform comprising a platform body 200 and a scanning unit of any of the above embodiments.

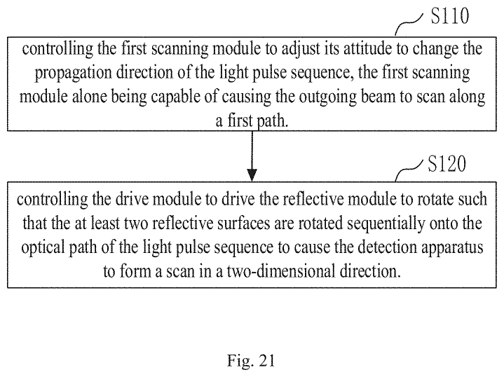

Referring to FIG. 21, some embodiments of the present application also provide a control method for a detection apparatus that can be used with the detection apparatus of any of the above embodiments.

The detection apparatus includes a light source, a first scanning module and a second scanning module; the second scanning module includes a reflective module and a drive module, the reflective module includes at least two reflective surfaces.

The specific principles and implementation of the detection apparatus provided by this application embodiment are similar to the detection apparatus of the preceding embodiments, and will not be repeated here.

Referring to FIG. 21, the control method comprises step S110 and step S120.

S110, controlling the first scanning module to adjust its attitude to change the propagation direction of the light pulse sequence, the first scanning module alone being capable of causing the outgoing beam to scan along a first path.

S120, controlling the drive module to drive the reflective module to rotate such that the at least two reflective surfaces are rotated sequentially onto the optical path of the light pulse sequence to cause the detection apparatus to form a scan in a two-dimensional direction.

In some embodiments, the first scanning module comprises a reflector and a drive mechanism. The controlling the first scanning module to adjust its attitude comprises:

controlling the drive mechanism to drive the reflector to swing back and forth along the first path extension direction.

In some embodiments, the controlling the drive module to drive the reflective module to rotate comprises:

controlling the drive module to drive the reflective surface in the reflective module to rotate around the second path extension direction.

In some embodiments, the control method further comprises.

outputting a sequence of point cloud frames based on the scanning results, each point cloud frame in the sequence of point cloud frames comprising a two-dimensional array of point clouds.

In some embodiments, the first scanning module comprises a reflector and a drive mechanism; the controlling the first scanning module to adjust its attitude comprises:

controlling the drive mechanism to drive the reflector to oscillate back and forth in a stepwise manner.

In some embodiments, the control method further comprises:

outputting a sequence of point cloud frames; wherein the driving mechanism is used to drive the reflector to start in a first attitude and end in a second attitude, wherein the reflector oscillates from the first attitude to the second attitude after a number of steps in the same direction, during the sampling duration corresponding to each of the two adjacent point cloud frames.

In some embodiments, the control method comprises:

acquiring point cloud data when the reflector moves from the first attitude to the second attitude, and not acquiring point cloud data when the reflector moves from the second attitude to the first attitude.

In some embodiments, the control method comprises:

controlling the light source to emit a sequence of light pulses during the time period when the reflector moves from the first attitude to the second attitude, and not to emit a sequence of light pulses during the time period when the reflector moves from the second attitude to the first attitude.

In some embodiments, the control method comprises:

controlling the driving mechanism to drive the reflector to swing multiple steps in the same direction from the first attitude to the second attitude, and to drive the reflector to swing one step from the second attitude back to the first attitude.

In some embodiments, multiple blackout periods occur during rotation of the reflective module, the blackout periods comprising the length of time during which two adjacent edge regions of the reflective surfaces are located on the optical path of the light pulse sequence; the control method comprising:

controlling the reflector by the drive mechanism to oscillate during at least a partial numbers of blackout periods.

In some embodiments, the control method comprises:

outputting a sequence of point cloud frames and controls the reflector by the drive mechanism to oscillate during each blackout period that occurs within a point cloud frame.

In some embodiments, the control method comprises:

controlling the reflectors by the driving mechanism to remain stationary during the non-blackout periods between two adjacent blackout periods.

In some embodiments, the control method comprises:

controlling the drive mechanism to communicate with the drive module of the reflective module to control the oscillation of the reflector according to the rotation angle of the reflective module.

In some embodiments, the first scanning module comprises a drive mechanism, a first prism and a second prism; the control method comprising:

controlling the drive mechanism to drive the first prism and the second prism to oscillate at equal speed and controlling the drive module to drive the reflective module to rotate at equal speed.

In some embodiments, the first scanning module comprises a drive mechanism, a first prism and a second prism; the control method comprising:

controlling the drive mechanism to drive the first prism and the second prism to oscillate at variable speed and controlling the drive module to drive the reflective module to rotate at equal speed.

In some embodiments, the control method comprises:

controlling the drive mechanism to drive the first prism and the second prism to oscillate in a sine wave variable speed manner.

In some embodiments, the first scanning module comprises a drive mechanism, a first prism and a second prism; the controlling the first scanning module to adjust its attitude, comprising:

drives the first prism to rotate at an equal speed in reverse with the second prism via the drive mechanism.

In the description of this application, it should be noted that, unless otherwise expressly specified and limited, the terms “mounted” and “connected” are to be understood broadly, for example, as fixed connection, removable connection, or integral connection. It can be a mechanical connection or an electrical connection. It can be a direct connection or an indirect connection through an intermediate medium, a connection within two components or an interaction between two components. To a person of ordinary skill in the art, the specific meaning of the above terms in the context of this application can be understood on a case-by-case basis.

In this application, unless otherwise expressly specified and limited, the first feature “on” or “under” the second feature may include direct contact between the first and second features, or it may include contact between the first and second features not directly, but through a separate feature between them. The first and second features may be in direct contact with each other, or the first and second features may not be in direct contact with each other, but through another feature between them. Also, the first feature being “above”, “on” and “over” the second feature includes the first feature being directly above and diagonally above the second feature, or simply indicating that the first feature is horizontally higher than the second feature. The first feature being “below”, “under” and “below” the second feature includes the first feature being directly below and diagonally below the second feature, or simply indicating that the first feature is less than the horizontal height of the second feature.

The above disclosure provides a number of different implementations or examples used to implement the different structures of the present application. To simplify the disclosure of this application, the components and settings of particular examples are described above. They are, of course, examples only and are not intended to limit the present application. In addition, the present application may repeat reference numbers and/or reference letters in different examples, such repetition being for the purpose of simplicity and clarity and not in itself indicative of a relationship between the various embodiments and/or settings discussed. In addition, the present application provides examples of various specific processes and materials, but one of ordinary skill in the art may be aware of other applications of processes and/or the use of other materials.

In the description of this specification, reference to the terms “an embodiment”, “some embodiments”, “schematic embodiment”, “example”, “specific example”, or “some example” means that the specific method steps, features, structures, materials, or characteristics described in conjunction with the embodiment or example are included in at least one embodiment or example of the present application. In this specification, the schematic expressions for the above terms do not necessarily refer to the same embodiment or example. Further, the specific method steps, features, structures, materials, or characteristics described may be combined in any one or more of the embodiments or examples in a suitable manner.

The above mentioned is only a specific implementation of the present application, but the scope of protection of the present application is not limited to this, and any person skilled in the art can easily think of various equivalent modifications or substitutions within the technical scope disclosed in the present application, which should be covered by the scope of protection of the present application. Therefore, the scope of protection of this application shall be subject to the scope of protection of the claims.

What is claimed is:

1. A detection apparatus, comprising:
a light source to emit a light pulse sequence;
a first scanner and a second scanner disposed in an optical path of the light pulse sequence to change propagation direction of the light pulse sequence, the first scanner alone being capable of causing an outgoing light beam to scan along a first path, and the second scanner alone being capable of causing the outgoing light beam to scan along a second path;
wherein the first scanner includes a reflector and a first driver to drive the reflector to swing back and forth in a stepwise manner; and
the second scanner includes a reflective structure and a second driver, the reflective structure including at least two reflective surfaces, the second driver drives the reflective structure to rotate so that the at least two reflective surfaces are rotated sequentially onto the optical path of the light pulse sequence to cause the detection apparatus to form a scan in a two-dimensional direction.

2. The detection apparatus according to claim 1, wherein the detection apparatus outputs a sequence of point cloud frames,
wherein, during sampling duration corresponding to each of two adjacent point cloud frames, the first driver drives the reflector to start in a first attitude and end in a second attitude, the reflector oscillating from the first attitude in the same direction for a plurality of steps and then moving to the second attitude.

3. The detection apparatus according to claim 2, wherein the detection apparatus acquires point cloud data during a period when the reflector moves from the first attitude to the second attitude; the detection apparatus does not acquire point cloud data during a period when the reflector moves from the second attitude to the first attitude, and/or.
the light source emits the light pulse sequence during the period when the reflector moves from the first attitude to the second attitude, and does not emit a light pulse sequence during the period when the reflector moves from the second attitude to the first attitude.

4. The detection apparatus according to claim 3, wherein the first driver drives the reflector to swing the plurality of steps in the same direction from the first attitude to the second attitude, and drives the reflector to swing one step back from the second attitude to the first attitude.

5. The detection apparatus according to claim 1, wherein during rotation of the reflective structure, a plurality of blackout periods occurs and the first driver controls oscillation of the reflector during at least part of the number of blackout periods, and
the blackout period comprises at least one of a duration of edge regions of two adjacent reflective surfaces lying on the optical path of the light pulse sequence, a duration of an junction region of two adjacent reflective surfaces lying on the optical path of the light pulse sequence, or a duration of the nearest reflective surface of the at least two reflective surfaces to the optical path of the light pulse sequence being approximately parallel to the optical path of the light pulse sequence.

6. The detection apparatus according to claim 5, wherein the first driver controls the reflector to remain stationary during a non-blackout period between two adjacent blackout periods.

7. The detection apparatus according to claim 5, wherein the first driver communicates with the second driver to control the oscillation of the reflector according to a rotation angle of the reflective structure.

8. The detection apparatus according to claim 2, wherein the reflector oscillates at least one step when the detection apparatus switches from one point cloud row to another point cloud row, or the reflector oscillates at least one step when the detection apparatus switches from one point cloud frame to another point cloud frame.

9. The detection apparatus according to claim 8, wherein during the rotation of the reflective structure, there are a number of blackout periods, the first driver controls the oscillation of the reflector during at least part of the number of blackout periods, the blackout periods each being greater than or equal to a switching duration of point cloud rows or point cloud frames of the detection apparatus.

10. The detection apparatus according to claim 9, wherein the first driver drives the reflector from the second attitude to the first attitude for a period less than or equal to one of the blackout periods.

11. The detection apparatus according to claim 9, wherein the reflector oscillates for at least one step during one of the blackout periods.

12. The detection apparatus according to claim 1, wherein the first driver drives the reflector to oscillate at an even or variable speed and the second driver drives the reflective structure to rotate at an even speed.

13. The detection apparatus according to claim 12, the first driver comprises a stepper motor.

14. The detection apparatus according to claim 1, wherein the at least two reflective surfaces are connected end to end and are provided in a centrosymmetric or rotationally symmetric manner around a rotation axis of the reflective structure.

15. The detection apparatus according to claim 14, wherein the at least two reflective surfaces are parallel to the rotation axis of the reflective structure respectively.

16. The detection apparatus according to claim 14, wherein at least one of the at least two reflective surfaces is not parallel to the rotation axis of the reflective structure, an angle between the one of the at least two reflective surfaces and the rotation axis of the reflective structure being an acute angle.

17. The detection apparatus according to claim 16, wherein one of the at least two reflective surfaces has an angle of +β degrees with the rotation axis of the reflective structure, and another of the at least two reflective surfaces has an angle of −β degrees with the rotation axis of the reflective structure, where β is a value greater than 0.

18. The detection apparatus according to claim 14, wherein the reflective structure comprises three reflective surfaces.

19. The detection apparatus according to claim 1, wherein the detection apparatus further comprises a collimating structure to collimate the light pulse sequence emitted by the light source, the collimating structure and the first scanner disposed in sequence along the optical path of the light pulse sequence from the light source.
wherein a spot formed by the outgoing beam of the light source on the collimating structure is offset from a center of the collimating structure.

20. A movable platform, comprising.
a platform body; and
a detection apparatus disposed on the platform body to provide distance information for the movable platform, the detection apparatus comprising:
a light source to emit a light pulse sequence;
a first scanner and a second scanner disposed in an optical path of the light pulse sequence to change propagation direction of the light pulse sequence, the first scanner alone being capable of causing an outgoing light beam to scan along a first path, and the second scanner alone being capable of causing the outgoing light beam to scan along a second path;
wherein the first scanner includes a reflector and a first driver to drive the reflector to swing back and forth in a stepwise manner; and
the second scanner includes a reflective structure and a second driver, the reflective structure including at least two reflective surfaces, the second driver drives the reflective structure to rotate so that the at least two reflective surfaces are rotated sequentially onto the optical path of the light pulse sequence to cause the detection apparatus to form a scan in a two-dimensional direction.
